(19) United States
(12) Patent Application Publication
(10) Pub. No.: US 2026/0290376 A1
(43) Pub. Date: Sep. 24, 2026

(54) SYSTEM

(71) Applicant: SoftBank Group Corp., Tokyo (JP)

(72) Inventor: Toshiki TABATA, Tokyo (JP)

(73) Assignee: SoftBank Group Corp., Tokyo (JP)

(21) Appl. No.: 19/560,268

(22) Filed: Mar. 9, 2026

(30) Foreign Application Priority Data
Mar. 19, 2025 (JP) 2025-044555

(51) Int. Cl. G10L 25/63; G06N 3/0475; G06N 3/0499

(52) U.S. Cl. CPC G10L 25/63; G06N 3/0475; G06N 3/0499

(57) ABSTRACT

A system includes a processor that is configured to generate a prompt for instructing a generative AI model to analyze organization information, input the generated prompt into the generative AI model to cause the generative AI model to analyze the organization information, and generate a growth strategy based on an analysis result obtained from the generative AI model.

### CROSS-REFERENCE TO RELATED APPLICATION

This application is based on and claims priority under 35 USC 119 from Japanese Patent Application No. 2025-044555 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional approaches to developing growth strategies for organizations largely rely on manual analysis performed by human experts, who must review diverse types of organization information, such as business type, size, products or services, and market environment. This manual process is time-consuming, costly, and heavily dependent on the experience and intuition of individual experts, which can result in inconsistent quality and limited scalability when handling large volumes of organization information. Furthermore, although generative AI models have become capable of producing complex analytical and strategic content, there is no standardized system that systematically generates prompts for such generative AI models based on structured organization information, supplies the prompts and information to the models, and obtains consistent growth strategies in a repeatable workflow. In addition, existing systems do not provide a unified mechanism by which humans can efficiently verify or validate growth strategies proposed by generative AI models, nor do they seamlessly integrate organization information entered via widely used spreadsheet software into the prompt generation and strategy creation process. Therefore, there is a need for a system that can automatically generate prompts for instructing a generative AI model to analyze organization information, that can generate growth strategies based on analysis results from the generative AI model, and that can facilitate human verification of the generated growth strategies while flexibly accepting organization information from spreadsheet software.

### SUMMARY

In order to solve the above-described problems, a system is provided that comprises a processor configured to generate a prompt for instructing a generative AI model to analyze organization information, input the generated prompt into the generative AI model to cause the generative AI model to analyze the organization information, and generate a growth strategy based on an analysis result obtained from the generative AI model. In one embodiment, the processor is further configured to provide a verification mechanism for enabling a human to verify the growth strategy proposed by the generative AI model, thereby allowing human evaluators to confirm, correct, or refine the generated growth strategy and to ensure that the strategy is appropriate for actual business use. In another embodiment, the processor is further configured to obtain the organization information that has been input into spreadsheet software and to generate the prompt for instructing the generative AI model to analyze the organization information, thereby enabling the system to utilize organization information maintained in a common and familiar format. By integrating prompt generation, AI-based analysis, growth strategy generation, and human verification within a single processor-controlled workflow that accepts organization information from spreadsheet software, the system can efficiently produce consistent and high-quality growth strategies for various organizations.

The term “system” refers to a combination of hardware and software components configured to execute the processing defined in the claims, including at least one processor and any necessary memory, storage, communication interfaces, and execution environment.

The term “processor” refers to any hardware device or combination of devices capable of executing instructions, such as a central processing unit (CPU), a graphics processing unit (GPU), a microcontroller, a digital signal processor, or a plurality of such devices operating together.

The term “generative AI model” refers to a software-implemented machine learning or artificial intelligence model that, in response to input data or prompts, produces output data such as text, numerical values, or structured information, and that is capable of generating new content or analyses not explicitly stored in a predefined database.

The term “organization information” refers to data describing characteristics of an organization, including but not limited to business type, size, products or services, market environment, financial indicators, operational data, and any other information relevant to analyzing the organization's current state and potential growth.

The term “prompt” refers to information, including text or structured data, that is provided to a generative AI model in order to instruct the generative AI model to perform a specific task, such as analyzing organization information or generating a growth strategy.

The term “growth strategy” refers to a plan, proposal, or set of recommendations generated based on the analysis of organization information, which is intended to improve or expand the organization's business, performance, market presence, or profitability.

The term “analysis result” refers to information output by the generative AI model in response to the prompt and the organization information, the information including, for example, identified patterns, relationships, opportunities, risks, or summarized insights regarding the organization.

The term “verification mechanism” refers to functionality implemented by the system that allows a human to review, evaluate, confirm, modify, or reject a growth strategy proposed by the generative AI model, and that may include user interfaces, workflows, or tools for providing feedback or annotations.

The term “spreadsheet software” refers to application software that allows a user to enter, manage, and manipulate data in a tabular format composed of rows and columns, such as spreadsheet programs that can store data in files including CSV, XLS, or XLSX formats.

The term “obtain the organization information that has been input into spreadsheet software” refers to reading, importing, or otherwise acquiring organization information from a file, data source, or interface associated with spreadsheet software, so that the organization information can be used as input for prompt generation and subsequent analysis.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

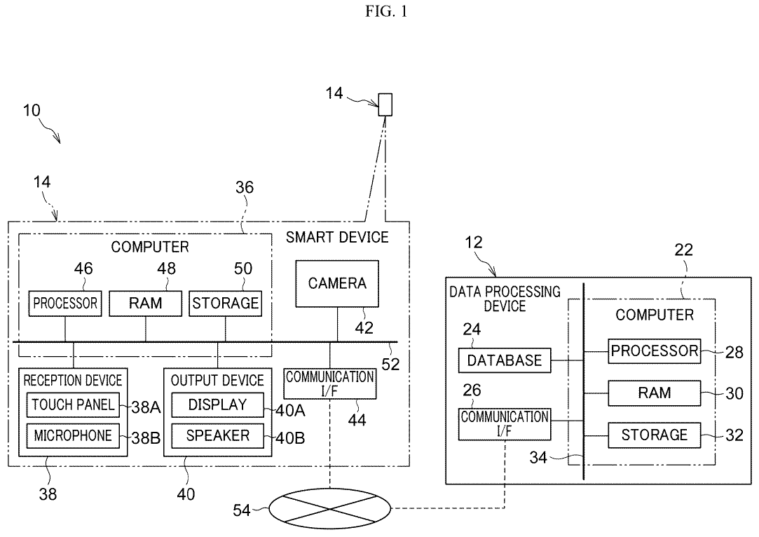

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

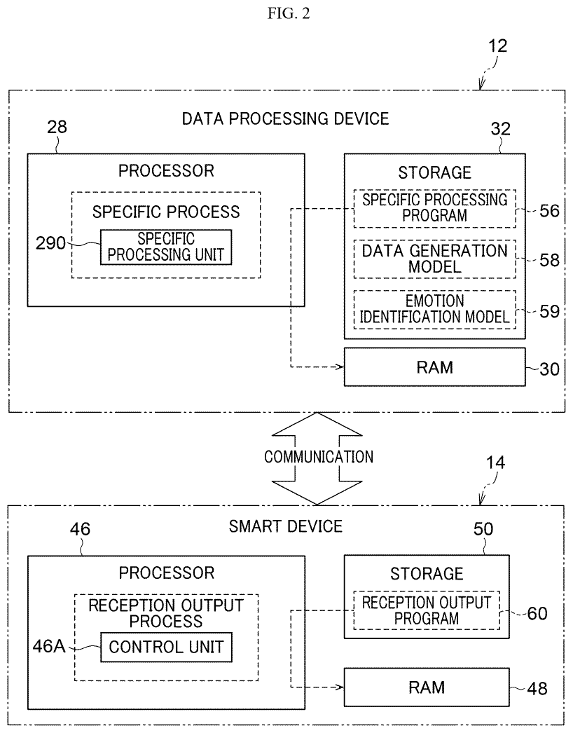

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented systems for strategy planning typically rely on static rule sets or manual, human-crafted analyses to evaluate organizational data and propose growth strategies. In such systems, the role of the computing device is largely limited to storing, displaying, and aggregating data, while the substantive reasoning regarding inter-organizational synergy, growth potential, and prioritization of strategies is performed manually. As a result, these systems suffer from several technical problems.

First, conventional systems do not provide an integrated data processing pipeline that transforms heterogeneous organization information, entered for example through spreadsheet applications, into a machine-interpretable representation suitable for automated generative analysis. Missing data, categorical attributes, and scale differences between numerical fields are often handled ad hoc or left unresolved, leading to inconsistent or unusable inputs for advanced models. This limits the ability of the computing device to automatically and reliably utilize complex models such as generative AI models.

Second, even when generative AI models are employed, existing approaches typically apply such models in a simplistic, one-shot manner: the model generates text based on a prompt, and the generation is then manually interpreted and evaluated by human operators. The computing system itself does not perform systematic self-evaluation, scoring, or ranking of the generated strategies according to multiple quantitative criteria. Consequently, the computational resources are not effectively used to narrow down and prioritize the large space of possible strategies, and users must manually filter and compare the outputs.

Third, conventional systems do not effectively reuse intermediate computational artifacts, such as preprocessed datasets or internal analysis results generated by AI models, across multiple prompts or iterations. When a user changes conditions or enters a new prompt sentence, the system often re-executes the entire analysis pipeline from raw spreadsheet data, causing redundant computations, increased latency, and inefficient utilization of processing units and memory subsystems.

Fourth, the interaction between user input (including prompt sentences) and back-end analysis is not well structured in known systems. User prompts are often treated as free-form text without deep integration with structured organization data and synergy indicators computed by the system. This leads to a disconnect between the structured numeric information processed by the computer and the textual instructions provided by the user, reducing the effectiveness and reliability of the generative analysis.

Accordingly, there is a need for an improved computer-implemented system that: (i) converts heterogeneous organization information into normalized analysis data through an automated preprocessing pipeline; (ii) uses a generative AI model, conditioned on both analysis data and user-provided prompt sentences, to compute indicators of inter-organizational synergy and to generate multiple candidate growth strategies; (iii) automatically performs multi-criteria self-evaluation and ranking of the generated strategies within the computing environment; and (iv) reuses preprocessed data and analysis results across different prompts to reduce redundant computation and improve overall system performance. By addressing these technical issues, the invention aims to improve the functioning of the computer system itself with respect to processing organization information and generating, evaluating, and prioritizing growth strategies in an efficient and objective manner.

The specific processing by the specific processing unit 290 of the data processing device 12 in Example 1 is realized by the following means.

The present invention provides a server comprising a processor configured to receive machine-readable organization information that has been input at a terminal device via a tabular data processing program, to convert the machine-readable organization information into analysis data by executing an automated preprocessing pipeline including complementing missing information, converting categorical attribute information into numerical representations, and normalizing numerical information, to execute a generative AI model using the preprocessed analysis data together with a user-specified prompt sentence in order to generate analysis result data including indicators representing synergy among a plurality of organizations, to generate, based on the analysis result data and the prompt sentence, a plurality of text-based growth strategy candidates that utilize the synergy among the plurality of organizations, to compute, for each of the growth strategy candidates, evaluation indices including growth potential, risk level, investment effectiveness, and feasibility and to assign a self-evaluation score to each growth strategy candidate based on the corresponding evaluation indices, to rank the plurality of growth strategy candidates in order of priority according to the self-evaluation scores and to output a ranking result to the terminal device, and to store the preprocessed analysis data and the analysis result data in a storage device in a reusable form and, upon reception of the same or a different prompt sentence, to generate and rank additional growth strategy candidates by reusing the stored data. This enables the server to improve the technical functioning of the computer system by creating an integrated, machine-executable pipeline that transforms heterogeneous organization information into normalized model-ready data, conditions a generative AI model on both structured analysis data and prompt sentences, automatically performs multi-criteria scoring and ranking of generated strategies without requiring manual evaluation, and reduces redundant computations through reuse of intermediate analysis results, thereby enhancing computational efficiency, consistency of evaluations, and responsiveness of the system.

The term “terminal device” refers to an information processing apparatus used by a user to input, display, and transmit data, such as a general-purpose computing device, a portable computing device, or a communication-enabled device, which executes a tabular data processing program and communicates with a server over a communication network.

The term “server” refers to an information processing apparatus including at least one processor and at least one storage device, configured to receive data from a terminal device, execute data processing and model inference, store intermediate and final results, and return processing results to the terminal device via a communication network.

The term “processor” refers to a hardware processing unit or a combination of hardware processing units, such as a central processing unit, a graphics processing unit, or another arithmetic processing unit, capable of executing machine-readable instructions to perform data processing, model execution, scoring, and ranking as described herein.

The term “tabular data processing program” refers to an application program executed on a terminal device that allows a user to input, edit, and manage data arranged in rows and columns, and to export such data in a machine-readable format.

The term “organization information” refers to data relating to an entity engaged in activities such as commerce, industry, or services, including at least one of industry category, scale, product or service characteristics, and market environment attributes.

The term “machine-readable data” refers to data encoded in a structured format interpretable by a computer program, such as a delimited text file, a binary spreadsheet format, or a structured text representation, that can be programmatically parsed and processed without manual intervention.

The term “analysis data” refers to a data representation obtained from machine-readable data through preprocessing, which is structured and normalized so as to be suitable for numerical computation and input to a machine learning model or generative AI model.

The term “preprocessing” refers to a series of automated data transformation operations applied to raw or machine-readable data, including at least one of complementing missing information, converting categorical attributes into numerical representations, and normalizing numerical values.

The term “complementing missing information” refers to detecting absent, null, or invalid data entries in the organization information and replacing such entries with substitute values determined by a rule, a statistical method, or a model-based estimation method.

The term “categorical attribute information” refers to organization information that denotes membership in a discrete set of categories, such as industry type, region, or product type, rather than a continuous numeric quantity.

The term “numerical information” refers to organization information expressed as numeric values, such as counts, financial amounts, or other quantitative measures that can be subjected to arithmetic operations.

The term “converting categorical attribute information into numerical representations” refers to transforming categorical attribute information into numeric codes, vectors, or other numeric formats that can be processed by a machine learning model or generative AI model.

The term “normalizing numerical information” refers to transforming numerical values according to a scaling rule, such as scaling to a specific range or standardizing to a zero-mean, unit-variance distribution, to improve numerical stability and model performance.

The term “generative AI model” refers to a machine learning model that, when executed by a processor, is configured to generate new data, including at least text-based content, conditioned on input data and one or more control signals such as a prompt sentence.

The term “prompt sentence” refers to a user-specified natural language expression or instruction that is provided as input to a generative AI model in order to condition or control the content, style, or scope of the model's generated output.

The term “analysis result data” refers to data output by the generative AI model or associated processing, including at least indicators representing relationships or synergies among a plurality of organizations and other intermediate representations used for generating strategies.

The term “indicator representing synergy” refers to a quantitative or structured value that expresses the strength, potential, or quality of cooperative effects between at least two organizations, as derived from organization information by computational analysis.

The term “growth strategy candidate” refers to a proposed plan, described at least partly in text form, that specifies one or more actions or policies intended to enhance the growth or performance of one or more organizations, and that is generated by the generative AI model or by processing of its outputs.

The term “text-based growth strategy candidate” refers to a growth strategy candidate whose main representation is a natural language text sequence generated or assembled by a computing system.

The term “evaluation index” refers to a value calculated by the processor according to a predetermined rule or model, representing a specific aspect of the quality or suitability of a growth strategy candidate, such as growth potential, risk level, investment effectiveness, or feasibility.

The term “growth potential” refers to an evaluation index indicating an expected degree of improvement in measures such as revenue, market share, or organizational expansion resulting from implementing a given growth strategy candidate.

The term “risk level” refers to an evaluation index indicating a magnitude or likelihood of adverse outcomes associated with implementing a given growth strategy candidate, including at least market, operational, or financial risks.

The term “investment effectiveness” refers to an evaluation index indicating a relationship between resources or costs required to implement a growth strategy candidate and the expected benefits, such as return on investment or cost-effectiveness.

The term “feasibility” refers to an evaluation index indicating an anticipated ease or practicality of implementing a growth strategy candidate, considering constraints such as time, resources, organizational capabilities, and external conditions.

The term “self-evaluation score” refers to a composite value automatically computed by the processor for each growth strategy candidate, based on one or more evaluation indices, and used by the system to compare and prioritize the growth strategy candidates without requiring manual scoring.

The term “ranking result” refers to data indicating an ordered list of growth strategy candidates arranged according to their self-evaluation scores or other ranking metrics, including at least information on relative priority or position.

The term “storage device” refers to a hardware component or combination of components, such as a non-volatile memory device, a magnetic storage device, or a solid-state storage device, configured to store data, models, and intermediate results for subsequent retrieval and processing.

The term “reusable form” refers to a representation of data, such as preprocessed analysis data or analysis result data, that is stored together with associated metadata such that it can be directly or efficiently used again by the processor for subsequent generation and evaluation of growth strategy candidates without re-executing the entire preprocessing or analysis pipeline.

In one embodiment, a server cooperates with a terminal and a user to implement the claimed system. The server includes at least one processor, a main memory, a non-volatile storage device, and a network interface. The terminal includes at least one processor, a display device, an input device, and a network interface. The user operates the terminal to input organization information and prompt sentences, and to review and select growth strategy candidates output from the server.

The terminal executes a tabular data processing program. The terminal uses, for example, spreadsheet software such as a generic spreadsheet application running on an operating system. The terminal stores organization information in a tabular data structure having rows corresponding to organizations and columns corresponding to attributes such as an industry category, a scale, a product or service characteristic, and a market attribute.

The server executes one or more server-side programs on a processor. The server uses an operating system and application software implemented, for example, in a general-purpose programming language. The server stores organization information and intermediate data in a storage device such as a solid-state drive or a hard disk drive. The server uses a database system to persist identifiers, preprocessed datasets, model parameters, and evaluation scores.

The server uses software libraries for numerical computation and data manipulation. In one embodiment, the server uses a numerical computation framework such as a tensor processing library and a data-frame library. The server uses a machine learning framework such as a deep learning library to implement and execute a generative AI model. The generative AI model is, for example, a transformer-based neural network including an encoder and a decoder. The encoder processes numerical organization features and optional textual features. The decoder generates text sequences representing growth strategies.

The server internally represents input organization information as a structured data object. The server converts a tabular file received from the terminal into an in-memory data structure such as a two-dimensional array or a data-frame. The server maps each column of the table to a predefined feature type. For example, the server maps an “industry” column to a categorical feature, maps a “number of employees” column to a continuous numerical feature, and maps a “region” column to another categorical feature. The server maintains a schema definition that associates each column name with a feature encoding rule.

The server performs automated preprocessing. The server detects missing values in the organization information by checking for null entries, empty strings, or predefined missing value tokens. The server complements missing values using rule-based or statistical methods. For numeric fields, the server computes a column-wise aggregate such as a mean or median and substitutes the aggregate value for missing entries. For categorical fields, the server selects a most frequent category or a dedicated “unknown” category and substitutes that category for missing entries. The server logs the positions of complemented entries for later inspection.

The server converts categorical attributes into numerical representations. The server assigns integer indices to categorical labels and converts each category into a one-hot vector or an embedding index. The server constructs a high-dimensional numeric feature vector for each organization by concatenating numeric attributes and encoded categorical attributes. The server then normalizes the numeric attributes by applying a scaling transformation. In one embodiment, the server applies a standardization transformation that subtracts a mean and divides by a standard deviation, computed over the training set or over the current dataset. In another embodiment, the server applies a min-max scaling transformation to map values into a fixed range such as [0, 1].

The server builds a tensor from the normalized features. The server arranges the feature vectors of multiple organizations into a two-dimensional tensor having dimensions corresponding to a batch size and a feature dimension. The server stores this tensor in main memory or in a device memory associated with a graphics processing unit. The server uses this tensor as an input to the generative AI model.

The server trains or uses a pre-trained generative AI model. The server defines a neural network architecture including multiple layers of self-attention, feed-forward sublayers, and normalization layers. The server uses multi-head attention mechanisms to compute context-dependent representations of each organization feature vector, capturing relationships such as potential synergy between organizations. The server implements a loss function combining reconstruction loss, language modeling loss, and optionally a synergy prediction loss. The server updates model parameters during an offline training phase by computing gradients of the loss function with respect to the model parameters and applying an optimization algorithm such as stochastic gradient descent with momentum, adaptive moment estimation, or a similar method. The server performs backpropagation through the neural network to propagate error signals from the output layer to earlier layers.

The server uses training data that includes historical organization information, known partnership outcomes, and human-labeled growth strategies. The server augments training data by applying data augmentation operations, such as perturbing numeric features within realistic ranges, mixing organization groups, or rephrasing textual descriptions. The server thus improves robustness and generalization capability of the model.

The server uses an encoder subnetwork to compute latent vectors for each organization. These latent vectors represent compressed, multi-dimensional features that capture industry, scale, market, and other characteristics relevant to synergy analysis. The server constructs combined representations for pairs or groups of organizations by applying operations such as concatenation, element-wise addition, and attention-based pooling. The server outputs a synergy indicator for each organization pair or group by feeding the combined representation through one or more feed-forward layers and a final activation function. The synergy indicator is, for example, a scalar value in a predetermined range indicating predicted synergy strength.

The server also uses a decoder subnetwork configured as a language model. The server represents a prompt sentence as a sequence of token identifiers and converts the token identifiers into token embeddings. The server feeds the token embeddings and the organization latent vectors into the decoder. The decoder uses cross-attention mechanisms to attend from prompt tokens to organization representations. The decoder generates output tokens one by one, conditioned on previous tokens and on the organization context, thereby producing a text-based growth strategy candidate.

The user inputs a prompt sentence at the terminal. The user, for example, enters a sentence in a text field of a web-based interface. Example prompt sentences include:

“Analyze the growth potential of manufacturing organizations with more than 500 employees and propose growth strategies that leverage synergies between them.”

“Using the provided organization data for manufacturing companies with over 500 employees, generate at least five concrete partnership and business expansion strategies that maximize synergy and minimize risk.”

“Using the uploaded spreadsheet of manufacturing firms with 500 or more employees, identify complementary capabilities and propose step-by-step growth strategies, including timelines, required investments, and expected outcomes.”

The terminal transmits the prompt sentence to the server together with a reference to the relevant dataset. The server tokenizes the prompt sentence using a tokenizer associated with the generative AI model, and converts the prompt into embeddings by an embedding layer.

The server generates multiple growth strategy candidates for a single prompt. The server invokes a decoding procedure such as beam search, top-k sampling, or nucleus sampling. The server controls sampling parameters such as a beam width, a temperature parameter, a top-k value, or a top-p value, to balance diversity and relevance of generated strategies. The server collects multiple candidate texts and associates each candidate with the underlying synergy indicators that influenced its generation.

The server applies an internal evaluation module to each growth strategy candidate. The server uses a scoring network that accepts as input a vector representation of the strategy text and optionally numerical summary features derived from the synergy indicators and organization attributes. The server obtains the vector representation by applying a text encoder, for example a transformer encoder, to the candidate text. The server then passes the encoded vector through a multi-layer perceptron to output multiple evaluation indices such as a growth potential score, a risk score, an investment effectiveness score, and a feasibility score. The server combines these indices into a composite self-evaluation score using a weighted formula stored in configuration data.

The server stores evaluation indices and self-evaluation scores in a structured data store. The server maintains a record for each strategy candidate including fields for a strategy identifier, text content, individual evaluation indices, and overall score. The server sorts this collection based on the overall score and assigns a rank to each candidate. The server transmits the ranked list to the terminal. The terminal displays the ranked list in a graphical user interface, allowing the user to review and select one or more strategies.

The server stores preprocessed analysis data and analysis result data in a reusable form. The server assigns unique identifiers to preprocessed datasets and synergy analysis outputs. The server writes these data objects to the storage device along with metadata describing the preprocessing parameters, feature encodings, and model versions. When the user submits a new prompt sentence referring to the same organizations, the server reuses the stored tensors and synergy indicators rather than repeating the entire preprocessing and synergy computation. This reuse reduces computation time, reduces load on the processor and memory subsystem, and improves responsiveness without sacrificing accuracy.

The server improves computer technology by introducing a specific, integrated data pipeline and model architecture that are optimized for multi-organization synergy analysis and text generation. The preprocessing stage standardizes heterogeneous organization information into model-ready tensors, which maximize numerical stability and minimize errors due to inconsistent scaling or missing values. This directly improves inference accuracy and convergence behavior of the underlying neural network. The use of stored preprocessed data and analysis results reduces redundant computations and thereby decreases processor cycles and memory bandwidth usage. This improvement is not achievable by manual human analysis and goes beyond a mere automation of mental steps.

The server uses non-conventional scoring and ranking procedures tailored to generated strategies. Instead of relying solely on human judgment, the server employs an internal scoring network that has been trained to approximate expert assessments under multiple criteria. By encoding both generated text and numeric synergy features, the scoring network exploits high-dimensional patterns that human evaluators cannot easily capture or reproduce consistently. The server therefore provides more stable and reproducible evaluations, which results in lower variance and reduced error rates in strategy selection.

The server also enforces non-standard control flow between modules. For example, the server conditions the decoder of the generative AI model not only on text prompts but also on structured synergy indicators computed by the encoder. This architecture ensures that generated strategies are tightly coupled to computed synergies rather than generic business clichés. The server thereby transforms the computing device from a generic text generator into a specialized technical apparatus that computes and uses internal synergy metrics as control signals for generation. This internal use of computed indicators represents a machine-centric rule set that differs fundamentally from conventional rule-based expert systems or manual reasoning.

The server may employ alternative neural architectures in other embodiments. In one embodiment, the server uses a graph neural network to represent organizations as nodes and potential synergies as edges, and computes graph embeddings that are then used by a text decoder. In another embodiment, the server uses a variational autoencoder structure to learn latent distributions over organization groupings, which serve as priors for the generative decoder. In still another embodiment, the server uses a mixture-of-experts model where different expert subnetworks handle different industry sectors, and a gating network selects or weights experts based on the input dataset. In each case, the server maintains the functions of preprocessing, synergy indicator computation, generative output, evaluation, and ranking.

The server may adjust its evaluation behavior based on system-level constraints. For example, when processing capacity or network bandwidth is limited, the server reduces the number of generated candidates or uses cached results. By storing intermediate states and using adaptive batch sizes, the server optimizes memory usage and reduces data transfers between main memory and device memory. These features provide concrete improvements in computational efficiency and system throughput.

The terminal and the user can utilize the system in various domains. For example, the user can upload data relating to industrial organizations, service organizations, or mixed-sector organizations. The server can be applied to design collaborative supply chains, joint research projects, or shared service centers. The described technical mechanisms, including preprocessing, encoding, generative decoding, evaluation, and reuse of intermediate data, are independent of the specific business domain and serve to improve the technical performance of the computing system when handling complex multidimensional data and text generation tasks.

In summary, the server, the terminal, and the user cooperate to realize a system in which a generative AI model is integrated into a controlled, technically detailed pipeline. The system provides specific data structures, neural architectures, and scoring mechanisms that improve processing speed, accuracy, and reproducibility relative to conventional systems. The use of preprocessed tensors, structured synergy indicators, and reusable intermediate results directly enhances the computer's functioning and provides technical effects in terms of computation efficiency, error reduction, and effective utilization of processing and storage resources.

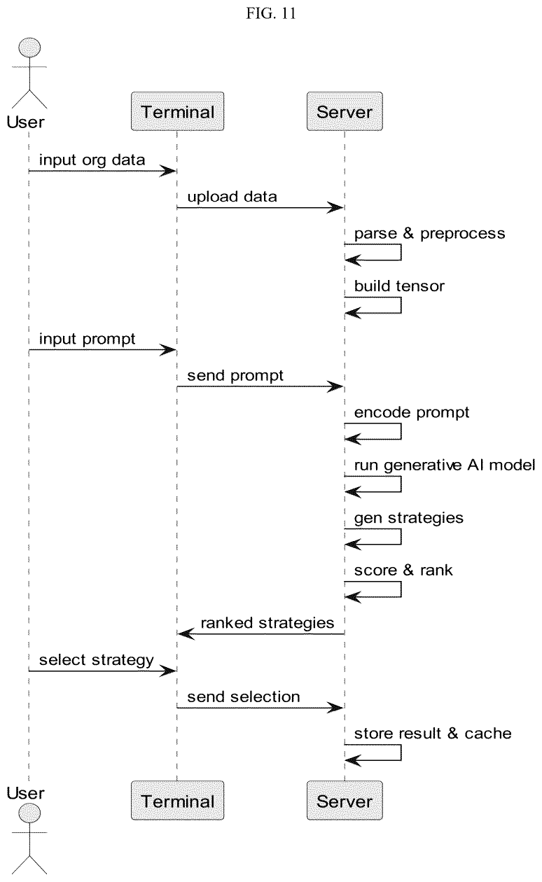

The following describes the processing flow using FIG. 11.

### Step 1:

User operates the terminal to input organization information.
User launches a tabular data processing program on the terminal and creates a table including columns such as organization identifier, industry category, number of employees, annual revenue, product or service type, and region. User types values into each cell, adds or deletes rows as needed, and saves the table. The input of this step is raw organization information known to the user, and the output is a structured table stored in the memory of the terminal as a spreadsheet file or in an in-memory table within the tabular data processing program.

### Step 2:

Terminal converts the table into machine-readable data and transmits it to the server.
Terminal takes the structured table created in Step 1 as input and exports the table into a machine-readable format such as a delimited text file or a binary spreadsheet file. Terminal then constructs a network request, attaches the exported file as payload, and sends the request to the server via a communication network. The terminal may add metadata such as user identifier and dataset name. The output of this step is a network message containing the machine-readable organization information, received by the server.

### Step 3:

Server stores the received machine-readable data and parses it into an internal data structure.
Server receives the network message from the terminal as input. Server extracts the attached file, assigns a dataset identifier, and stores the file in a storage device. Server then opens the file using a parsing module and converts the tabular contents into an in-memory data structure, such as a data frame where rows correspond to organizations and columns correspond to attributes. Server validates data types for each column and records any structural inconsistencies. The output of this step is a validated data frame or equivalent internal representation of the organization information.

### Step 4:

Server detects and complements missing information.
Server takes the data frame from Step 3 as input and scans each column for missing entries, such as empty cells or null markers. Server computes statistical aggregates like mean or median for numeric columns and most frequent values for categorical columns. Server replaces missing numeric entries with the chosen aggregate value and replaces missing categorical entries with the most frequent category or a designated “unknown” category. Server records which fields were complemented in a separate log structure. The output of this step is a cleaned data frame in which missing values have been complemented and a log describing complemented positions.

### Step 5:

Server converts categorical attributes into numerical representations.
Server uses the cleaned data frame from Step 4 as input and identifies columns that contain categorical data, such as industry category or region. Server maps each distinct category label to an integer index and generates numerical vectors, for example one-hot vectors or embedding indices, for each categorical value. Server then constructs an extended feature vector for each organization by concatenating numeric attributes and encoded categorical vectors. The output of this step is a feature matrix in which each row is a numeric feature vector corresponding to an organization, along with mapping tables that define the correspondence between original categories and numeric codes.

### Step 6:

Server normalizes numerical attributes and builds an analysis tensor.
Server takes the feature matrix from Step 5 as input and computes scaling parameters, such as mean and standard deviation, for each numeric attribute. Server applies a normalization transformation to each numeric component in the feature vectors, for example by subtracting the mean and dividing by the standard deviation or by mapping values into a predefined range. Server then converts the normalized feature matrix into a tensor suitable for input to a generative AI model, for example a two-dimensional tensor stored as contiguous memory. The output of this step is a normalized input tensor and associated normalization parameters.

### Step 7:

User inputs a prompt sentence at the terminal and requests strategy generation.
User interacts with a user interface on the terminal and selects a dataset corresponding to the organization information already transmitted. User types a prompt sentence into a text input field, such as “Analyze the growth potential of manufacturing organizations with more than 500 employees and propose growth strategies that leverage synergies between them.” User then issues a request to generate growth strategies. The input of this step is the user's intention expressed as free-form text and the selection of a dataset, and the output is a request message sent from the terminal to the server containing the prompt sentence and a reference to the dataset identifier.

### Step 8:

Server tokenizes and encodes the prompt sentence.
Server receives the request from Step 7, extracts the prompt sentence as input, and applies a tokenizer that segments the prompt sentence into tokens based on a predefined vocabulary. Server maps each token to a token identifier and then passes the sequence of identifiers through an embedding layer to obtain a sequence of dense vectors representing the prompt. Server may add positional encodings to preserve token order. The output of this step is a sequence of prompt embeddings that can be used as conditioning input for the generative AI model.

### Step 9:

Server computes organization representations and synergy indicators using the generative AI model encoder.
Server loads the normalized input tensor from Step 6 and the prompt embeddings from Step 8 as input to the encoder portion of the generative AI model. Server processes the input tensor through multiple layers of linear transformations, non-linear activation functions, and attention mechanisms to compute latent representations for each organization. Server calculates pairwise or groupwise synergy indicators by combining latent representations, for example via attention-based pooling or feed-forward layers, and outputs scalar synergy values or vectors indicating potential synergy strengths. The output of this step is a set of latent organization vectors and a set of synergy indicators derived from those vectors.

### Step 10:

Server generates multiple text-based growth strategy candidates using the decoder.
Server uses the prompt embeddings and the synergy-related latent representations from Step 9 as input to the decoder portion of the generative AI model. Server initializes a decoding process and, starting from a special start token, repeatedly predicts the next token probability distribution conditioned on previous tokens and the context representation. Server samples or selects tokens using a decoding algorithm such as beam search or top-k sampling to form complete sentences and paragraphs. Server repeats this decoding process multiple times to obtain several distinct growth strategy candidates. The output of this step is a collection of text sequences, each describing a proposed growth strategy that utilizes computed synergies.

### Step 11:

Server encodes each generated growth strategy candidate for evaluation.
Server takes each text-based growth strategy candidate generated in Step 10 as input. Server uses a text encoder to tokenize and embed the candidate text, producing a fixed-length or pooled vector representation for each candidate. Server may also attach numeric summary features derived from the synergy indicators and organization attributes. The output of this step is a set of evaluation vectors, each corresponding to a generated growth strategy candidate.

### Step 12:

Server calculates evaluation indices and self-evaluation scores.
Server processes each evaluation vector from Step 11 through an evaluation network or scoring module implemented as one or more neural network layers or other mathematical functions. Server outputs multiple evaluation indices for each candidate, including a growth potential index, a risk index, an investment effectiveness index, and a feasibility index. Server then combines these indices into a composite self-evaluation score by applying a predefined weighted formula or another aggregation rule. The input of this step is the evaluation vectors, and the output is a structured set of evaluation indices and a single self-evaluation score for each growth strategy candidate.

### Step 13:

Server ranks growth strategy candidates according to self-evaluation scores.
Server collects all self-evaluation scores from Step 12 as input and sorts the associated growth strategy candidates in descending order of score. Server assigns rank numbers and constructs a ranked list where each element contains the strategy text, evaluation indices, and overall score. The output of this step is a ranking result data structure that explicitly orders all candidates by priority.

### Step 14:

Server transmits the ranking result to the terminal.
Server takes the ranking result from Step 13 as input and formats it into a response message including, for each candidate, at least the rank, strategy text, and key evaluation indices. Server sends the response over the communication network to the terminal. The output of this step is a network message carrying the ranked growth strategy candidates and their associated evaluation data.

### Step 15:

Terminal displays the ranked growth strategy candidates and accepts user selection.
Terminal receives the response message from Step 14 as input and parses the ranking result.
Terminal renders a user interface that lists growth strategy candidates in order of rank and displays details such as evaluation scores. User reads the displayed information and selects one or more candidates through interaction with input controls. Terminal records the selected candidate identifiers and generates a selection message. The output of this step is user selection data transmitted from the terminal to the server.

### Step 16:

Server records the selected growth strategy and stores reusable intermediate data.
Server receives the user selection from Step 15 as input. Server marks the selected growth strategy candidates in a persistent store and associates them with the corresponding dataset and prompt sentence. Server also stores the preprocessed tensor, latent organization representations, synergy indicators, and other intermediate results in a reusable format with metadata describing processing parameters. The output of this step is an updated storage state that includes records of selected strategies and cached intermediate computations, enabling faster and more efficient processing of subsequent prompt sentences referencing the same or related organization information.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented decision support systems that utilize machine learning or rule-based engines to process organizational information typically operate as single-pass analyzers that map input data directly to recommendations. Such systems have several technical limitations when applied to planning of production lines that combine technologies and products from multiple organizations.

First, conventional systems do not provide a standardized, machine-optimized mechanism for transforming heterogeneous organizational data stored in tabular files into structured inputs suitable for generative AI models. For example, differences in units, formats, missing values, and categorical labels often require manual curation. When such preprocessing is performed ad hoc by human operators or simple scripts, the quality and consistency of the data encoding varies, which degrades model performance and makes it difficult for the computing apparatus to efficiently extract synergistic relationships among organizations.

Second, conventional systems typically invoke a generative AI model only once, to obtain a recommendation or plan from given input data. They do not orchestrate a multi-stage, prompt-driven pipeline in which: (i) a first prompt focuses the model on synergy analysis, (ii) a second prompt uses that analysis to generate multiple structured candidate business growth plans, and (iii) a third prompt instructs the model to perform a self-evaluation of those plans according to explicit, quantifiable criteria. As a result, existing systems rely on human experts to perform the decomposition of the problem and the evaluation of candidate plans, which introduces latency, inconsistency, and limited scalability and prevents the computing system from using the generative AI model as an internal evaluation component.

Third, existing approaches generally lack a mechanism in which the computing system automatically converts the model's self-evaluation into numerical scores and ranks multiple generated plans within the infrastructure of the system. This absence of an integrated ranking pipeline forces downstream applications to process unstructured natural-language output, which often leads to unreliable parsing, ambiguous interpretations, and additional computational overhead to extract structured metrics and rankings suitable for subsequent processing or display.

Fourth, conventional systems do not maintain a closed feedback loop between user-specified constraints and the generative AI model's internal reasoning. That is, when a human operator changes constraints such as budget, throughput, or partner preferences, conventional tools often require manual reconfiguration, re-prompting, and ad hoc reinterpretation of results. There is no consistent computer-implemented mechanism to programmatically encode such constraints into updated prompt sentences, systematically re-run synergy analysis, candidate plan generation, and self-evaluation, and then update ranked lists in a traceable, reproducible manner.

Fifth, conventional systems have limited capabilities for systematically logging and reusing prompt sentences, intermediate model outputs, and evaluation results as first-class data objects within the system. Without persistent storage and reuse of this information, it is difficult to iteratively refine prompt templates, adjust evaluation criteria, or optimize the overall computational pipeline. This leads to inefficiencies in how the computing system orchestrates generative AI calls, and hinders improvement of model behavior over time.

Accordingly, there is a need for a computer-implemented technique that (i) automatically converts heterogeneous tabular organizational information into structured, analyzable data, (ii) systematically generates and manages prompt sentences for a generative AI model across multiple processing stages, (iii) uses the generative AI model not only for proposal generation but also for internal self-evaluation of generated plans, (iv) converts the model's evaluation output into numerical scores and ranking information inside the system, and (v) maintains a closed feedback loop with user-provided constraints and persistent logging of prompts and results. Such a technique improves the functioning of the computer system itself by enabling more reliable, repeatable, and structured interaction with a generative AI model, thereby enhancing the efficiency and technical quality of planning production lines and business growth strategies based on organizational data.

The specific processing by the specific processing unit 290 of the data processing device 12 in Application Example 1 is realized by the following means.

The present invention provides a server comprising a processor configured to acquire attribute information regarding a plurality of organizations from an electronic file in which the attribute information is stored as tabular data, perform preprocessing including missing-value completion, format unification, and normalization of categorical values on the attribute information to convert the attribute information into structured data that is analyzable, generate one or more prompt sentences that summarize the structured data and instruct a generative artificial intelligence model to (i) analyze synergistic effects among the plurality of organizations based on the structured data, (ii) generate, based on an analysis result regarding the synergistic effects, a plurality of candidate business growth plans including candidate production process configurations that combine technologies and products of different organizations, and (iii) perform a self-evaluation process on each of the candidate business growth plans according to predefined evaluation criteria including productivity improvement, cost efficiency, implementation difficulty, and risk, input the prompt sentences into the generative artificial intelligence model and obtain, from the generative artificial intelligence model, the analysis result regarding the synergistic effects, the plurality of candidate business growth plans, and numerical evaluation values and evaluation reasons corresponding to the evaluation criteria, rank the plurality of candidate business growth plans based on the numerical evaluation values to generate a priority list of the candidate production process configurations, output the priority list to an external device, and store, in a recording medium, at least the prompt sentences, the analysis result regarding the synergistic effects, the plurality of candidate business growth plans, and the results of the self-evaluation process so that a configuration of the prompt sentences or the evaluation criteria is changeable based on stored information. This enables the computer system to automatically transform heterogeneous organizational data into structured inputs, orchestrate multi-stage interactions with a generative AI model through explicitly generated prompt sentences, internally utilize the generative AI model both for proposal generation and quantitative self-evaluation, convert unstructured model output into ranked, machine-usable production process configurations, and iteratively refine prompt designs and evaluation criteria based on logged interactions, thereby improving the technical performance, reliability, and scalability of computer-implemented planning of production lines and business growth strategies.

The term “processor” refers to a hardware computation unit or a combination of hardware computation units, such as a central processing unit or graphics processing unit, configured to execute instructions and perform arithmetic and logical operations for implementing functions of the system.

The term “attribute information” refers to data items that describe characteristics of an organization, including but not limited to industry category, scale, products or services, equipment, production capacity, and market environment.

The term “electronic file” refers to a machine-readable data structure stored on a storage medium, including but not limited to a tabular data file such as a spreadsheet file or a comma-separated value file.

The term “tabular data” refers to data arranged in rows and columns, where each row typically represents an entity such as an organization and each column represents an attribute of that entity.

The term “preprocessing” refers to a series of data processing operations performed prior to analysis or model input, including operations such as completing missing values, unifying data formats, and normalizing categorical values.

The term “missing-value completion” refers to a data processing operation in which absent or null values in a dataset are replaced with estimated or default values according to predetermined rules or statistical methods.

The term “format unification” refers to a data processing operation in which different representations of the same type of information, such as date formats or unit systems, are converted into a consistent representation according to predefined rules.

The term “normalization of categorical values” refers to a data processing operation in which categorical entries, such as textual labels, are standardized or encoded into a consistent set of categories or numerical representations suitable for computational processing.

The term “structured data that is analyzable” refers to data that has been organized into a defined schema or representation, such as key-value pairs, tables, or vectors, that can be processed by algorithms or machine learning models.

The term “prompt sentence” refers to a textual input, including natural language instructions and optionally embedded structured data, provided to a generative artificial intelligence model in order to cause the model to perform a specified task.

The term “generative artificial intelligence model” refers to a machine learning model configured to produce new data, such as text or structured output, based on input data and learned parameters, including but not limited to a large language model.

The term “synergistic effects” refers to advantageous interactions that arise when technologies, products, or capabilities from multiple organizations are combined, such that the combined effect exceeds the sum of individual effects.

The term “analysis result regarding synergistic effects” refers to output data that indicates relationships, compatibilities, or complementarities among organizations, technologies, or products, including qualitative descriptions or quantitative measures of synergy.

The term “business growth plan” refers to a structured proposal that describes how an organization or a group of organizations can improve operations, expand production, or increase value, including configurations of production processes and resource allocations.

The term “candidate business growth plan” refers to one of a plurality of alternative business growth plans generated for comparison and evaluation.

The term “production process configuration” refers to an arrangement of processing steps, equipment, and resource flows within a production line or manufacturing system.

The term “candidate production process configuration” refers to one of a plurality of alternative configurations of processing steps and equipment arrangements proposed for evaluation.

The term “self-evaluation process” refers to a process in which the generative artificial intelligence model, in response to a prompt sentence, outputs evaluation information about generated plans according to predefined criteria, without direct human scoring.

The term “evaluation criteria” refers to one or more predetermined measures or aspects, such as productivity improvement, cost efficiency, implementation difficulty, and risk, used to assess and compare business growth plans.

The term “productivity improvement” refers to an expected increase in output per unit of input, such as units produced per hour or per resource, achieved by implementing a business growth plan.

The term “cost efficiency” refers to an expected reduction or optimization of total cost, including capital expenditure and operating expense, per unit of output associated with a business growth plan.

The term “implementation difficulty” refers to a measure of complexity or effort required to realize a business growth plan, including required time, technical challenges, and organizational changes.

The term “risk” refers to potential negative outcomes associated with implementing a business growth plan, including technical failures, delays, or financial losses.

The term “numerical evaluation value” refers to a quantitative score or rating assigned to a business growth plan for a given evaluation criterion, typically represented as a number within a predetermined range.

The term “evaluation reason” refers to explanatory information, usually in natural language, that describes why a particular numerical evaluation value has been assigned.

The term “priority list” refers to an ordered list in which candidate business growth plans or candidate production process configurations are arranged according to a ranking based on their evaluation values.

The term “external device” refers to any device separate from the server that receives output data, including but not limited to a client terminal, display device, or another computing system.

The term “display device” refers to a hardware component configured to present visual information to a user, including but not limited to a monitor, a tablet display, or a mobile device screen.

The term “operator” refers to a human user who interacts with the system, including entering constraints or conditions and reviewing displayed results.

The term “additional conditions or constraint conditions” refers to user-specified limitations or preferences, such as budget limits, required throughput, preferred partners, or other operational restrictions, that are used to influence analysis and plan generation.

The term “recording medium” refers to any non-transitory physical storage medium that can store data, such as a magnetic disk, optical disk, semiconductor memory, or solid-state drive.

The term “stored information” refers to data that has been written to and retained on a recording medium, including prompt sentences, analysis results, generated plans, and evaluation results.

The term “configuration of the prompt sentences” refers to the structural and content-related aspects of prompt sentences, including wording, ordering of information, level of detail, and format specifications.

The term “changeable based on stored information” refers to the capability of the system to modify parameters, templates, or rules, such as the configuration of prompt sentences or evaluation criteria, in response to previously recorded data.

In one embodiment, a server executes a computer program to implement the claimed system. The server includes at least one central processing unit (CPU), at least one graphics processing unit (GPU), a main memory, a non-transitory storage device such as a solid-state drive, a network interface, and an operating system such as a general-purpose server operating system. The server further includes application software implemented, for example, using a programming language and a data analysis library such as a numerical computing library and a data frame library. The server may also utilize a deep learning framework such as a tensor-based numerical library or a dynamic computation graph library to execute a generative AI model. A database management system such as a relational database is used to store intermediate and final data. A terminal operated by a user connects to the server via a communication network such as an IP network, and displays information and receives inputs through a web browser or a client application.

The server acquires organizational attribute information from an electronic file that stores tabular data, such as a spreadsheet file or a comma-separated value file. The server uses a data analysis library, for example a data frame library executed on the CPU, to read the tabular data into a memory-resident data structure, such as a table object in which each row corresponds to an organization and each column corresponds to an attribute (e.g., industry type, size, product category, production capacity, and market region). The server performs data preprocessing including missing-value completion, format unification, and categorical normalization. For missing-value completion, the server computes statistics such as median or mode on existing entries and writes replacement values into empty cells in the table object. For format unification, the server converts heterogeneous unit representations (e.g., “units/hour,” “units/day”) into a standard unit by multiplying or dividing numeric values and updating the stored unit identifier. For categorical normalization, the server maps synonymous category labels (e.g., “auto,” “automobile,” “vehicle industry”) into a canonical label by referring to a predefined mapping table stored in the database. As a result, the server transforms raw heterogeneous data into structured data that is analyzable and consistent in schema and units.

The server summarizes the structured data to construct prompt sentences for a generative AI model. The server generates text that lists each organization and its key attributes in a standardized template. The server inserts explicit instructions at the end of the text, specifying the desired computational task for the generative AI model. A representative prompt sentence generated by the server for synergy analysis is:

“The server provides the following organizational information:
1. Organization A: industry=automotive parts; main technology=high-precision robotic arms; production capacity=120 units per hour; strengths=precision and reliability.
2. Organization B: industry=consumer electronics; main technology=high-speed assembly machines; production capacity=200 units per hour; strengths=speed and flexible changeovers.
3. Organization C: industry=quality inspection equipment; main technology=AI-based vision inspection; strengths=high defect detection rate.

Analyze the potential synergies among these organizations. Identify which combinations of technologies could form efficient production lines and briefly explain the expected synergy effects.”

In this embodiment, the server executes a generative AI model implemented as a transformer-based neural network that has an encoder-decoder structure or a decoder-only structure. The model includes multiple attention layers, feed-forward layers, and normalization layers. The server stores model parameters (weights and biases) in the storage device and loads them into the GPU memory at runtime. The server tokenizes the prompt sentence into discrete tokens using a subword tokenizer and converts tokens into dense vectors via an embedding layer. The server performs matrix multiplications and non-linear activation operations over multiple attention heads and layers on the GPU to compute contextual representations of the tokens.

The server configures the generative AI model to output text in a semi-structured format (e.g., numbered lists or key-value pairs) to facilitate parsing. The server specifies generation parameters such as temperature, maximum number of output tokens, top-k or top-p sampling thresholds, and beam width. By controlling these parameters, the server optimizes computation time and output determinism, thereby improving reproducibility and reducing the need for additional post-processing.

The server obtains from the generative AI model an analysis result regarding synergistic effects. The server then constructs another prompt sentence that includes a summary of the synergy analysis and instructions to generate multiple candidate business growth plans. A representative prompt sentence used by the server for plan generation is:

“Based on the synergy analysis above, generate at least three candidate business growth plans that combine these organizations'technologies into optimal production lines for manufacturing electric vehicle control modules. For each plan, describe:
The target product and production volume
The sequence of processes and which organization's equipment is used at each step
The expected throughput, quality level, and main risks.”

The server again sends this prompt sentence to the generative AI model and obtains natural-language descriptions of candidate business growth plans. The server parses the output by detecting delimiters such as “Plan 1:”, “Plan 2:”, and so on. The server splits the raw output into multiple plan objects, each stored in the database with attributes such as target product, process steps, equipment allocation, and qualitative benefit descriptions.

The server further generates a prompt sentence for self-evaluation of the generated plans. The self-evaluation prompt explicitly encodes evaluation criteria and scoring rules so that the generative AI model produces structured numerical evaluation values. An example of such a prompt sentence is:

“The server has generated the following three plans (Plan 1, Plan 2, Plan 3). Evaluate each plan with scores from 1 to 10 for: (1) productivity improvement, (2) cost efficiency, (3) technical risk (lower is better, so invert when scoring), and (4) time to deployment. Provide an overall score and a short justification for each plan. Then indicate which plan appears most promising and why.”

The server instructs the generative AI model, through this prompt sentence, to apply non-human, model-internal evaluation rules learned from training data. The model processes each plan's description, encodes it into a latent representation, and computes output tokens representing numerical values and concise textual reasons. The server parses the model output, extracts scores and reasons, and stores them as numerical fields and text fields in the database. The server then executes ranking logic: the server computes a weighted sum or other aggregation function over the evaluation criteria for each plan and sorts the plans according to the aggregated score. This ranking is performed using data manipulation operations in the memory-resident data structures and, if needed, in the database with ordered queries.

The server outputs the ranked list of candidate production process configurations to the terminal. The terminal receives the ranked list via a network API and displays the priority list and associated details on a display device. The user can review the recommended configurations, including expected throughput and risk assessments. The user can further input additional constraints, such as maximum investment, minimal target throughput, preferred or excluded partners, or regulatory constraints. The terminal collects these inputs through form fields or text areas and transmits them to the server as structured parameters and optional free-text instructions.

The server incorporates these additional conditions or constraint conditions into updated prompt sentences. For example, the server may generate a prompt sentence such as:

“Given the following constraints: maximum investment of 5 million currency units, target output of 150 units per hour, and priority use of Organization A's robotic arms, adjust the previously generated business growth plans. Propose updated production line configurations that satisfy these constraints, and explain any trade-offs in cost, productivity, and risk.”

By encoding constraints into prompt sentences automatically and consistently, the server enables the generative AI model to re-compute plans under new conditions without manual redesign of the reasoning sequence. The server re-executes the synergy analysis, plan generation, and self-evaluation pipeline under the new constraints, then updates and re-displays the ranking. This closed-loop process provides a technical improvement in the way the computing system interacts with and controls a generative AI model.

The server continuously logs prompt sentences, synergy analyses, generated plans, and evaluation results onto a non-transitory recording medium. The server analyzes historical logs to refine prompt templates and evaluation criteria. For example, the server may compute statistics on output variance and parsing success rate for different prompt formulations, then automatically adjust prompt structure to reduce ambiguity and improve parsing reliability. This iterative refinement improves the precision and stability of model outputs, thereby reducing error rates and lowering the need for computationally expensive post-processing.

The server uses a specific data flow and module configuration. A data acquisition module reads tabular organizational data into memory. A preprocessing module executes missing-value completion, format unification, and categorical normalization using deterministic algorithms. A prompt construction module assembles textual prompt sentences with embedded structured summaries and explicit instructions. An AI interaction module handles tokenization, model invocation, and output collection using a deep learning framework on the GPU. A parsing and structuring module converts raw text outputs into structured records. An evaluation and ranking module computes aggregated scores and sorts plan records. A logging and refinement module writes prompts and results to storage and can update configuration parameters for subsequent interactions. This modular design and data flow are tailored to generative AI-based planning and differ from generic business workflow automation.

In one variation, the server executes the generative AI model locally on a GPU resource, which reduces communication latency and allows fine-grained control of batch sizes and inference parallelization. The server can process multiple prompt sentences in parallel batches on the GPU by stacking token sequences into a single tensor. This parallelization improves throughput and reduces overall computation time compared to serial, user-driven interactions with a remote model. The server can also cache intermediate embeddings for organizational descriptions so that repeated analyses with different constraints reuse previously computed representations rather than re-encoding the same text, further reducing computational load.

In another variation, the server uses a remote generative AI service accessed over the network. The server still performs local preprocessing, prompt construction, output parsing, and ranking. In this case, the server reduces network bandwidth usage by compressing and summarizing tabular data before embedding it in prompt sentences, for example by clustering organizations and reporting only representative attributes. This reduces the token length of prompts and the size of transmitted data, thereby lowering communication load and improving responsiveness.

The server improves computer technology in several ways. First, by standardizing and automating the conversion from heterogeneous tabular data to structured, model-ready data and prompt sentences, the server reduces data inconsistency and manual intervention, leading to more reliable and faster machine processing. Second, by orchestrating a multi-stage generative AI pipeline—synergy analysis, plan generation, and self-evaluation—using explicit, machine-generated prompt sentences, the server enables the generative AI model to perform complex internal reasoning that is decomposed and controlled at the system level, rather than relying on a single monolithic request. This decomposition reduces errors, enhances interpretability, and increases computational efficiency because each stage can be tuned and optimized separately.

Third, by converting self-evaluation output into numerical scores and rankings inside the system, the server transforms unstructured textual outputs into structured decision-support data without relying on human interpretation. This structured ranking can be directly used for machine control of downstream processes or for integration with planning systems. Fourth, by logging and analyzing prompt-response pairs and updating prompt configurations, the server implements a technical feedback mechanism that incrementally improves the interaction between the computing system and the generative AI model over time, resulting in improved accuracy and stability of outputs.

Because the server implements specific data structures, modules, and processing flows tailored to generative AI-based planning and evaluation, the system is not merely automating human mental steps. Instead, the server uses non-conventional, model-aware processing steps—such as automatic prompt construction, internal self-evaluation loops, and structured ranking—to improve computation speed, reduce parsing errors, and optimize communication with the model. These technical improvements enable more efficient and reliable computer-implemented planning of production lines and business growth strategies, and can be applied in real-world manufacturing environments where the ranked output from the server is used to configure or adjust operational planning systems and, in further embodiments, to control production equipment settings according to selected configurations.

In yet another embodiment, the server can be connected to a manufacturing execution system. The server can supply the highest-ranked production process configuration to a downstream control system that maps process steps to machine parameters. By providing a structured and ranked configuration, the server reduces the computational burden on the manufacturing execution system, as that system no longer needs to perform complex combinatorial planning. This chain from organizational data, through generative AI-based analysis and ranking, to machine-level planning demonstrates how the claimed system is technically integrated with real-world apparatus control and contributes to improved configuration accuracy and reduced setup time for production lines.

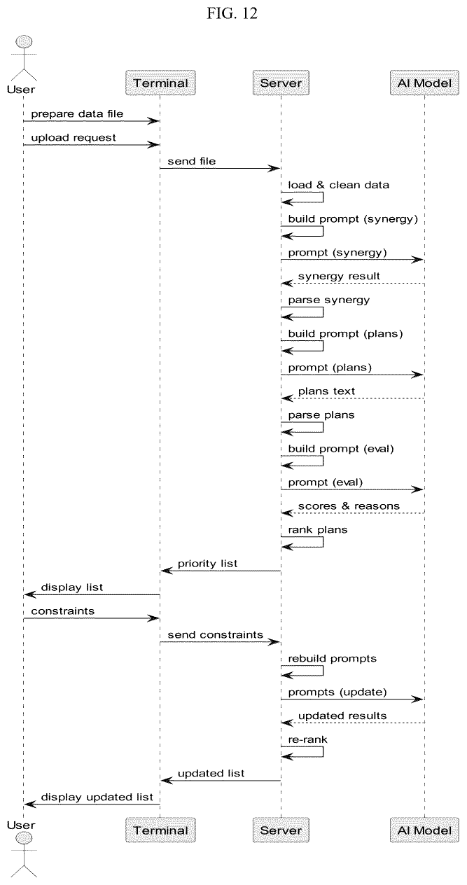

The following describes the processing flow using FIG. 12.

### Step 1:

The user prepares organizational data in a tabular format.
The user uses spreadsheet software on the terminal to create an electronic file that contains rows representing organizations and columns representing attributes such as industry category, organization size, product type, equipment type, production capacity, and target market. As input, the user provides domain information and numerical values, and as output, the user stores a spreadsheet or comma-separated value file on a local storage device.

### Step 2:

The terminal transmits the organizational data file to the server.
The terminal receives a file selection from the user, attaches metadata such as file name and file type, and sends an HTTP or HTTPS request containing the file as input to the server. The output of the terminal is a network message including the binary content of the electronic file. The terminal uses a web browser or client application to perform this operation.

### Step 3:

The server receives and stores the uploaded file.
The server accepts the network request as input via a network interface and a web application framework, validates the file type, and writes the uploaded file to a storage device such as a solid-state drive. The server also records the file path and user identifier in a database table. The output of this step is a stored file location and a database record linking the user to the dataset.

### Step 4:

The server loads tabular data into a structured in-memory representation.
The server reads the stored file path as input, uses a data analysis library to open the spreadsheet or comma-separated value file, and converts the tabular data into a table object in memory, where each cell is accessible via row and column indices. The server parses headers, infers data types, and stores the result as a structured data table. The output is a memory-resident table structure suitable for further computation.

### Step 5:

The server performs missing-value completion.
The server takes the table structure as input and scans each column to detect missing or null entries.
For numerical columns, the server computes aggregate statistics such as mean or median and replaces missing values with these statistics. For categorical columns, the server uses the most frequent category or a designated default value. The server writes the completed values back into the table. The output is a modified table in which all required fields contain valid data.

### Step 6:

The server executes format unification for numeric and temporal data.
The server uses the cleaned table as input and examines fields that represent quantities with units or time values. The server parses each value, detects unit labels (for example, “per day” or “per hour”), and converts the numeric component to a standard unit using multiplication or division. For dates and times, the server converts various textual formats into a single standardized format. The output is a table where all quantity and time fields share consistent units and formats, enabling straightforward mathematical operations.

### Step 7:

The server normalizes categorical values.
The server takes the formatted table as input and focuses on categorical fields such as industry, region, and equipment type. The server compares each category label to entries in a mapping table stored in the database and replaces synonyms or variations with a canonical label. The server also assigns internal identifiers or encoded values to each canonical category. The output is a table in which categorical values are standardized and mapped to internal codes, reducing ambiguity and improving compatibility with machine learning processes.

### Step 8:

The server converts the cleaned table into model-ready structured data.
The server uses the normalized table as input and transforms each organization's row into a structured record such as a key-value dictionary or a fixed-length feature vector. The server encodes categorical fields using techniques such as index mapping or one-hot encoding and preserves numerical fields in normalized form. The server may group records into a list or array for batch processing. The output is a structured dataset that can be easily embedded into prompt sentences or used as input for auxiliary models.

### Step 9:

The server constructs a prompt sentence for synergy analysis.
The server takes the structured dataset as input and generates human-readable text that lists each organization's key attributes in a unified format. The server concatenates attribute descriptions and adds explicit instructions to the generative AI model, such as a request to identify technology and product combinations that yield synergistic effects. The output of this step is a synergy-analysis prompt sentence in natural language that encodes both data and task instructions.

### Step 10:

The server sends the synergy-analysis prompt sentence to the generative AI model and obtains an analysis result.
The server receives the prompt sentence as input, tokenizes the text into tokens using a tokenizer, and feeds the tokens into a transformer-based generative AI model executed on a graphics processing unit. The model performs attention-based computations to derive contextual representations and generates output tokens that describe relationships, compatibilities, and complementary technologies among organizations. The server collects the generated text as output and stores it as a synergy-analysis result.

### Step 11:

The server parses and structures the synergy-analysis result.
The server uses the generated analysis text as input and applies pattern matching or simple parsing rules to extract individual synergy items, such as pairs or groups of organizations, descriptions of their interactions, and qualitative synergy strength indicators. The server writes these items into structured records stored in memory or in the database. The output is a set of structured synergy objects that link organizations and describe potential cooperative effects.

### Step 12:

The server constructs a prompt sentence for candidate business growth plan generation.
The server takes the structured synergy objects as input and summarizes the key synergy findings into a compact textual description. The server appends instructions requesting multiple candidate business growth plans that combine identified technologies into production process configurations.
The server explicitly asks for information such as target product, process sequence, equipment allocation, and expected benefits. The output is a plan-generation prompt sentence tailored to the synergy context.

### Step 13:

The server sends the plan-generation prompt sentence to the generative AI model and obtains candidate business growth plans.
The server tokenizes the plan-generation prompt sentence as input and passes the tokens to the generative AI model. The model computes probabilities over the token vocabulary step by step and outputs text describing several plans, typically distinguished by labels such as “Plan 1,” “Plan 2,” and “Plan 3.” The server collects the generated text as output and stores it as raw plan descriptions.

### Step 14:

The server parses the generated business growth plans into discrete plan objects.
The server uses the raw plan descriptions as input and detects delimiters such as plan numbers or headings. The server splits the text into separate segments, each representing a single candidate plan.
For each segment, the server extracts structured components such as target product, required equipment, process steps, and informal performance expectations. The server creates plan records in the database and associates them with the originating dataset and synergy analysis. The output is a collection of discrete plan objects prepared for evaluation.

### Step 15:

The server constructs a prompt sentence for self-evaluation of the candidate plans.
The server takes the plan objects as input and embeds each plan's description into a new textual template that enumerates evaluation criteria, including productivity improvement, cost efficiency, implementation difficulty, and risk. The server instructs the generative AI model to assign numerical scores to each criterion for each plan and to provide an overall score and brief justification. The output is an evaluation prompt sentence that systematically encodes the evaluation task and scoring rules.

### Step 16:

The server sends the evaluation prompt sentence to the generative AI model and obtains numerical evaluation values and evaluation reasons.
The server tokenizes the evaluation prompt sentence as input and submits it to the generative AI model. The model processes the descriptions of each plan and the evaluation criteria, then generates output tokens that represent structured scores and natural-language explanations. The server captures the generated text and parses out numerical scores for each criterion and each plan, as well as associated justification strings. The output is a structured evaluation dataset containing scores and reasons per plan.

### Step 17:

The server ranks the candidate business growth plans based on the evaluation values.
The server takes the structured evaluation dataset as input and computes an overall score for each candidate plan, for example by weighting individual criterion scores and summing or averaging them. The server then sorts the plans in descending order of overall score using a sorting algorithm applied to the plan records in memory or in database queries. The output is an ordered list in which each plan is assigned a rank and retains its associated scores and justifications.

### Step 18:

The server generates a priority list of candidate production process configurations and outputs it to the terminal.
The server takes the ranked plan list as input and constructs a response object that includes, for each plan, its rank, key process configuration details, numerical scores, and concise evaluation reasons.
The server serializes this information into a response format and sends it to the terminal through an application programming interface. The output is a priority list delivered over the network, ready for display to the user.

### Step 19:

The terminal displays the priority list and associated information to the user.
The terminal receives the response from the server as input and renders the priority list on a display device. The terminal shows ranking positions, plan summaries, and major evaluation scores in a list view, and allows the user to select a plan to see more detailed descriptions of production process configurations and risk profiles. The output is a graphical or textual presentation that the user can inspect and interact with.

### Step 20:

The user reviews the displayed plans and inputs additional conditions or constraint conditions.
The user observes the priority list and, based on domain requirements, decides to impose constraints such as a maximum investment budget, a required minimum throughput, preferred partners, or regulatory conditions. The user enters these conditions via form fields or free-text input on the terminal. The input is captured as structured parameters and constraint descriptions.

### Step 21:

The terminal transmits the additional conditions or constraint conditions to the server.
The terminal uses the user-entered conditions as input and packages them into a request that includes structured fields and, optionally, natural-language statements. The terminal sends this request to the server over the network. The output is a constraint update message delivered to the server.

### Step 22:

The server incorporates the additional conditions into updated prompt sentences and regenerates analysis, plans, and evaluations.
The server takes the constraint update message as input and modifies the prompt construction process. The server augments synergy-analysis, plan-generation, and evaluation prompt sentences with explicit references to the new constraints, thereby changing the model's computational objective. The server re-sends these updated prompt sentences to the generative AI model, obtains revised synergy analyses, new or adjusted business growth plans, and new evaluation scores, and re-ranks the plans. The output is an updated priority list that reflects the user's constraints.

### Step 23:

The server logs prompt sentences, analysis results, generated plans, and evaluation outputs for later refinement.
The server takes all prompt sentences, raw model outputs, parsed structures, scores, and rankings generated during the process as input and writes them to a recording medium along with timestamps and dataset identifiers. The server may compute summary statistics on these logs, such as parsing success rates or score distributions, and use these statistics to adjust internal parameters or templates in subsequent runs. The output is a persistent log repository that supports iterative improvement of prompt design and evaluation behavior.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented decision support systems for business growth planning typically rely on manually crafted rules, static scoring models, or simple statistical analysis. In such systems, a processor generally treats organization-related data as fixed input to a predetermined algorithm and outputs heuristic recommendations. This approach suffers from several technical limitations in terms of how data is processed and how models are utilized inside the computing environment.

First, conventional systems do not integrate, at the processor level, a unified pipeline that automatically preprocesses heterogeneous, table-structured organization-related data, generates machine-readable encodings, and then constructs prompt sentences optimized for interaction with a generative AI model. As a result, the utilization of generative AI models in existing systems is often ad hoc, requiring human operators to manually transform data into textual prompts. This manual intervention introduces latency, inconsistency in prompt quality, and increased computational overhead due to repeated, non-optimized conversions between structured and unstructured representations.

Second, conventional systems generally invoke generative AI models only once to obtain recommendations, without a structured, model-internal self-evaluation and ranking mechanism. Existing implementations require separate external tools or human operators to interpret the generated strategies, assign scores, and prioritize options. This fragmented workflow leads to inefficient use of processor resources and memory bandwidth, as data must be repeatedly transferred, re-encoded, and reanalyzed across different components. Furthermore, the lack of an integrated evaluation loop reduces the reliability and reproducibility of the output within the computing system.

Third, known systems are not configured to leverage the structure of table-data processing programs, such as row and column relationships, as a direct basis for automated preprocessing and prompt construction. In many cases, table data is exported and manually reshaped or scripted before it can be processed by learning models. This creates bottlenecks in data ingestion and increases the likelihood of inconsistent mappings between table cells and model input features. Consequently, existing architectures do not fully exploit the tabular structure to generate consistent, high-quality prompts and evaluation prompts that are optimized for generative AI models.

Fourth, conventional architectures do not provide a processor-driven feedback loop where user interaction with ranked strategies (for example, selection and modification requests) is automatically converted into additional prompt sentences and refined generation cycles. This absence of an integrated refinement mechanism prevents the system from efficiently updating and improving generated strategies using the same computational pipeline, thereby limiting adaptability and responsiveness.

Accordingly, there is a need for a computer-implemented technique that improves the way a processor acquires, preprocesses, encodes, and utilizes organization-related data, constructs prompt sentences for generative AI models, performs internal self-evaluation of generated strategies, and outputs ranked and refined strategies. Such a technique should enhance the efficiency, consistency, and reliability of generative AI-based analysis and recommendation within an information processing system, thereby improving the overall performance and technical capabilities of the underlying computer technology.

The specific processing by the specific processing unit 290 of the data processing device 12 in Example 2 is realized by the following means.

The present invention provides a server comprising a processor and a memory storing instructions that, when executed by the processor, cause the processor to receive, from a user terminal, a plurality of organization-related data items including table-structured data; execute preprocessing including missing-value completion, outlier removal, encoding, and numerical conversion on the organization-related data to generate preprocessed data; generate a prompt sentence for causing a trained information processing model including a generative AI model to analyze relationships and synergies among the organization-related data based on the preprocessed data; input the prompt sentence and the preprocessed data into the generative AI model to obtain analysis results including the relationships and the synergies; generate, based on the analysis results and the preprocessed data, a plurality of growth strategies in natural language by using the generative AI model; for each of the plurality of growth strategies, generate an evaluation prompt sentence describing an evaluation request for a plurality of evaluation indices including growth potential, risk level, and investment effect, input the evaluation prompt sentence and a corresponding growth strategy into the generative AI model or a separate information processing model to obtain numerical evaluation results, calculate a comprehensive evaluation value of each growth strategy based on the numerical evaluation results, and order the plurality of growth strategies based on the comprehensive evaluation values to assign ranking information and provide the growth strategies together with the ranking information to the user terminal as output data. This enables the computing system to internally and automatically transform table-structured organization-related data into optimized prompt sentences and encoded inputs for a generative AI model, perform integrated generation and self-evaluation of multiple candidate strategies, and output ranked, refined strategy information with reduced manual intervention, improved data handling efficiency, and enhanced reliability of AI-based decision support.

The term “processor” refers to a hardware or virtual computing unit, such as a central processing unit or a microprocessor core, that executes machine-readable instructions to perform arithmetic, logical, control, and input/output operations.

The term “memory” refers to a hardware storage resource, such as volatile memory or non-volatile memory, that stores instructions and data to be accessed and processed by the processor.

The term “user terminal” refers to an information processing apparatus, such as a client computer device or a portable electronic device, operated by a user and configured to transmit data to and receive data from a server via a communication network.

The term “organization-related data” refers to data items representing attributes or conditions of an entity such as a business body or an institution, including at least one of an industry type, a size, characteristics of a product or service, and a market environment.

The term “table-structured data” refers to data that is arranged in a tabular structure of rows and columns, such as data managed by a spreadsheet program or a relational table, in which each cell stores a value corresponding to a combination of a record and a field.

The term “preprocessing” refers to a sequence of data transformation operations applied prior to model input, including at least one of filling missing values, detecting and removing outliers, converting categorical values into encoded representations, and converting data into numerical formats suitable for computation.

The term “missing-value completion” refers to a data processing operation in which absent or undefined values in a dataset are replaced with substitute values according to a predetermined rule or statistical method.

The term “outlier removal” refers to a data processing operation in which data points that deviate from a normal or expected range beyond a predetermined threshold are identified and excluded or adjusted.

The term “encoding” refers to a transformation by which symbolic or categorical information is converted into a machine-readable representation, such as a numerical code or a vector representation, for use by an information processing model.

The term “numerical conversion” refers to a transformation process in which non-numeric data is converted into numeric values, and in which numeric data may be normalized, scaled, or otherwise adjusted for use as input to a computational model.

The term “preprocessed data” refers to data that has undergone one or more preprocessing operations, including at least missing-value completion, outlier removal, encoding, and numerical conversion, and that is ready for input to a learning model.

The term “information processing model” refers to a software-implemented computational model, such as a machine learning model or a statistical model, configured to receive input data, perform numerical operations, and output analysis results or predictions.

The term “generative AI model” refers to a type of information processing model that is configured to generate new data, such as text or other content, based on input data or prompt sentences, for example by probabilistically predicting output tokens or values.

The term “prompt sentence” refers to a sequence of symbols or words provided as input to a generative AI model, the sequence specifying an instruction, a context, or a request that conditions the generation or analysis performed by the model.

The term “analysis results” refers to output data produced by the information processing model or the generative AI model in response to provided inputs, the output data including at least one of inferred relationships, synergies, or scores associated with organization-related data.

The term “relationships” refers to associations or correlations between two or more organization-related data items, such as similarity, complementarity, or dependence, identified by the information processing model.

The term “synergies” refers to cooperative effects or combined benefits that are estimated to occur when two or more entities represented by organization-related data interact, collaborate, or are combined, where the combined effect exceeds the sum of individual effects.

The term “growth strategies” refers to computer-generated proposals or plans, expressed in natural language, that describe actions, policies, or initiatives for promoting expansion or development of an organization.

The term “evaluation indices” refers to quantitative or qualitative criteria, represented as measurable variables, used to assess properties of a growth strategy, including at least growth potential, risk level, and investment effect.

The term “growth potential” refers to an evaluation index representing an estimated degree or likelihood that a growth strategy will increase one or more performance measures, such as revenue, market share, or profit, over a future period.

The term “risk level” refers to an evaluation index representing an estimated magnitude or probability of negative outcomes, such as loss, instability, or failure, associated with execution of a growth strategy.

The term “investment effect” refers to an evaluation index representing an estimated efficiency or return achieved relative to resources expended when implementing a growth strategy, including at least cost-benefit characteristics.

The term “evaluation prompt sentence” refers to a prompt sentence that explicitly requests a generative AI model or another information processing model to evaluate one or more growth strategies with respect to specified evaluation indices and to output numerical or structured evaluation results.

The term “numerical evaluation results” refers to output values, expressed as numbers or numeric vectors, produced by a generative AI model or another information processing model in response to an evaluation prompt sentence, the output values representing scores or ratings for one or more evaluation indices.

The term “comprehensive evaluation value” refers to a single aggregated value computed for each growth strategy by combining a plurality of numerical evaluation results according to a predetermined calculation rule or weighting scheme.

The term “ranking information” refers to data indicating an order or priority among a plurality of growth strategies, derived from comparing comprehensive evaluation values, and including at least rank positions or relative ordering identifiers.

The term “output data” refers to data formatted for transmission from the server to the user terminal, including at least growth strategies, associated evaluation information, and ranking information, and suitable for display or further processing at the user terminal.

The term “table-data processing program” refers to an application program or service configured to create, edit, and manage table-structured data, including at least functionality for specifying rows, columns, and cell values and for performing computations on such data.

The term “application programming interface” refers to a set of callable functions, protocols, or interfaces provided by a program or service that allows another program to request operations or exchange data in a structured and programmatic manner.

The term “file transfer function” refers to functionality that enables a computing device or program to send or receive files, including table-structured data files, between different systems or components via a communication network or a storage medium.

In one embodiment, a server cooperates with one or more terminals operated by a user to implement the claimed system. The server includes at least one processor and at least one memory storing instructions, and is connected to the terminals via a communication network such as the Internet. The terminal is, for example, a personal computer, a tablet device, or a smartphone, and executes a table-data processing program such as spreadsheet software. The user operates the terminal to input organization-related data and to review growth strategies generated and evaluated by the server.

The server executes an operating system such as a general-purpose server operating system and runs application software including a web application framework, an interface module for a table-data processing program, a data preprocessing module, a model inference module for a generative AI model, an evaluation and ranking module, and a presentation module for output data. The server uses a machine learning framework such as a deep learning library to implement the generative AI model and other information processing models. The server uses a data analysis library such as a numerical computation library or a table data analysis library to perform preprocessing of organization-related data.

The terminal executes a table-data processing program that manages table-structured data in rows and columns. The user creates, on the terminal, a table that includes columns such as “Industry,” “Organization Size,” “Product/Service Characteristics,” and “Market Environment,” and the user inputs values for each target organization. The terminal stores the table data in a file or in an online storage associated with the table-data processing program. The terminal transmits the table-structured data and related metadata, such as sheet name and cell ranges, to the server by using an application programming interface or by uploading a data file over a secure communication channel.

The server receives the table-structured data from the terminal and stores the received data temporarily in the memory. The server converts the tabular data into an internal data structure, for example, a table-like structure or a record array that preserves the row and column relationships of the original table. The server performs missing-value completion by applying predetermined rules or statistical methods. For example, the server fills a missing organization size field with a median or most frequent value observed in the dataset. The server performs outlier removal by calculating statistics such as mean, standard deviation, or quantiles for quantitative fields and removes or caps values that exceed a specified threshold. The server executes encoding of categorical values, converting text labels such as industry types into one-hot vectors or integer indices. The server applies numerical conversion and normalization to continuous fields, such as scaling values to a fixed interval. The server stores these preprocessed features in a tensor data structure suitable for input to a neural network model.

The server constructs feature vectors for each organization by concatenating or combining encoded categorical features, normalized numerical features, and optional interaction features, such as pairwise products of selected fields. The server uses these feature vectors as input to an information processing model and to a generative AI model. In one embodiment, the server implements the generative AI model as a transformer-based neural network with multiple encoder and decoder layers, multi-head self-attention, layer normalization, and position-wise feed-forward networks. The server stores trained weight parameters of the model in the memory and loads them into the processor at inference time.

The server generates a prompt sentence in natural language based on the preprocessed data for a target organization or for a group of organizations. For example, the server constructs a text such as:

“The organization operates in the manufacturing industry, has a medium size, focuses on new product development, and faces a highly competitive market. Based on these conditions and potential synergies with other organizations, analyze possible relationships and propose detailed growth strategies.”

The server concatenates the prompt sentence with a compact textual summary of the feature vectors or with symbolic identifiers linked to internal feature embeddings. The server encodes this concatenated text into token sequences by using a tokenizer corresponding to the transformer-based generative AI model. The server then inputs the token sequences into the generative AI model along with optional auxiliary tensors derived from the feature vectors. The server executes a forward pass through the transformer architecture, which includes operations such as matrix multiplications for computing query, key, and value vectors, multi-head attention weighting, residual connections, and nonlinear activation functions such as rectified linear unit or similar functions.

The server obtains hidden state representations for each token position and uses them to predict output tokens that describe growth strategies. The server uses a decoding algorithm such as beam search or nucleus sampling to generate multiple diverse candidate growth strategies in natural language. The server collects output tokens and converts them back into text strings representing strategies such as “enter a new geographic market jointly with a complementary partner,” or “upgrade existing products and differentiate based on reliability and after-sales service.” Because the server combines structured feature tensors and optimized prompt sentences, the generative AI model can generate strategies that consistently reflect the original table-structured data without requiring the user to manually craft prompts for each case.

The server performs model-internal self-evaluation of each generated growth strategy. The server generates an evaluation prompt sentence that instructs a model to assign scores for specific evaluation indices. For example, the server constructs a text such as:

“Evaluate the following growth strategy for an organization in the manufacturing industry of medium size in a highly competitive market. Rate on a scale from 1 to 10 for (1) growth potential, (2) risk level, and (3) investment effect. Provide the three scores separated by commas. Strategy: [strategy text].”

The server inputs this evaluation prompt sentence together with the strategy text into either the same generative AI model, operating in an evaluation mode, or into a separate evaluation model, such as a regression network that receives an embedding of the strategy text and outputs three numeric scores. In one embodiment, the server uses the same transformer architecture with shared or partially shared parameters, but switches decoding from free-form text generation to constrained numeric output, where only token sequences representing digits and separators are allowed. This constrained decoding reduces ambiguity and improves the reliability of numeric outputs.

The server parses the numeric scores from the model outputs and stores them as growth potential, risk level, and investment effect values. The server calculates a comprehensive evaluation value by applying a predetermined weighting formula, for example, giving higher weight to growth potential and investment effect and subtracting a weighted risk term. The server performs these calculations using vectorized numerical operations in the processor, thereby minimizing memory access overhead and improving computational efficiency. The server sorts the strategies according to comprehensive evaluation values by using an efficient sorting algorithm, and the server assigns rank positions to each strategy.

The server packages the ranked strategies, including their texts, individual scores, and rank numbers, into a structured response and transmits this output data to the terminal. The terminal receives the response and renders a user interface, such as a web page or application screen, that displays the strategies in ranked order, together with summary scores. The user can select a strategy to open a detail view that shows the full natural-language description and the evaluation scores.

The server supports an interactive refinement process. When the user selects a particular strategy on the terminal and issues a modification request, for example by inputting additional constraints or preferences, the terminal transmits this information to the server. The server generates a refinement prompt sentence, such as:

“Refine the following growth strategy to reduce risk while maintaining growth potential for a medium-sized manufacturing organization in a highly competitive market. Strategy: [strategy text].”

The server inputs the refinement prompt and the original strategy text into the generative AI model, and the model generates a revised strategy that better fits the requested constraints. The server can repeat the evaluation and ranking process for the revised strategy or for a set of revised strategies, and the server sends updated results to the terminal. This closed feedback loop, implemented entirely via processor-executed instructions, reduces the need for manual redesign of strategies and enables rapid iteration using consistent internal evaluation criteria.

In another embodiment, the server cooperates directly with a table-data processing program through an application programming interface rather than through raw file upload. The server requests cell ranges and sheet structures via the API, obtains information about column names and data types, and automatically maps each column to specific features used in the model. For example, the server maps the “Industry” column to a categorical feature index, the “Size” column to a discrete size feature, and numeric indicators such as “Annual Sales” or “R&D Budget” to normalized continuous features. The server uses this structured mapping to generate prompt sentences that accurately reflect the semantics of each column and to create feature tensors with consistent ordering across different datasets. By processing table-structured data at the level of row and column semantics, the server avoids repeated ad hoc scripts and reduces data ingestion latency.

The server is configured to improve computer technology in several ways. The server performs missing-value completion and outlier removal as part of a uniform preprocessing pipeline that outputs tensors directly compatible with the generative AI model, eliminating the need for separate conversion steps. This reduces memory allocation overhead and shortens the time between data receipt and model inference. The server also constrains decoding during evaluation by restricting output tokens, thereby reducing the computational search space in generating numeric scores and increasing the accuracy and consistency of evaluation outputs. The server's automatic construction of prompt sentences from structured data prevents inconsistent human-authored prompts and improves the stability of generation quality across different users and datasets.

The server uses an internal synergy analysis mechanism based on organization embeddings. In one embodiment, the server trains an encoder network that maps feature vectors for organizations into an embedding space where distance and similarity reflect potential synergies. The encoder can be a feed-forward neural network or a transformer encoder. The server computes pairwise cosine similarity or dot-product scores between embeddings and identifies groups of organizations that exhibit high synergy. The server then summarizes these synergy clusters in a compact textual or symbolic form and inserts this summary into the prompt sentence, thereby informing the generative AI model of latent relationships that are not easily captured by manual rules. This embedding-based synergy computation automatically detects patterns across large numbers of organizations with reduced human intervention.

The server trains the generative AI model and the evaluation model using supervised or semi-supervised learning. The server defines a loss function that may include a prediction loss for next-token prediction, a regression loss for evaluation indices, and optionally a regularization term that encourages consistency between generated strategies and known successful outcomes. The server updates model weights by using gradient-based optimization methods such as stochastic gradient descent or adaptive optimization. The server may perform data augmentation by paraphrasing training prompts and strategy texts, thereby improving the robustness of the model to variations in wording. The training process is executed on dedicated hardware such as graphics processing units or specialized accelerators, and the trained weights are later deployed on the inference server.

By structuring the system around these concrete data structures, models, and algorithms, the server achieves technical effects beyond simple automation of human decision making. The unified preprocessing and feature encoding pipeline reduces redundancy and improves cache locality, thereby accelerating inference. The embedding-based synergy analysis and constrained prompt construction improve the precision and reliability of generated strategies compared to naive text-only prompting. The integrated self-evaluation and ranking mechanism reduces communication overhead between separate tools, since all generation, scoring, and ordering are carried out within a single server process. As a result, the system increases processing speed, enhances evaluation accuracy, reduces error rates in interpretation of model outputs, and provides more consistent, reproducible decision-support information to the user.

In alternative embodiments, the server may use different neural network architectures, such as recurrent networks, convolutional sequence models, or hybrid architectures combining a transformer encoder with a feed-forward decoder. The server may store organization-related data and model outputs in different database structures, such as columnar stores for efficient aggregation or key-value stores for quick retrieval of strategy histories. The server may adapt weighting schemes in the comprehensive evaluation calculation to different application domains. In all these embodiments, the server operates according to the same fundamental concept of acquiring table-structured organization-related data from a terminal, transforming the data into internal feature representations and optimized prompt sentences, invoking a generative AI model and associated evaluation models, and providing ranked, refined output data back to the terminal.

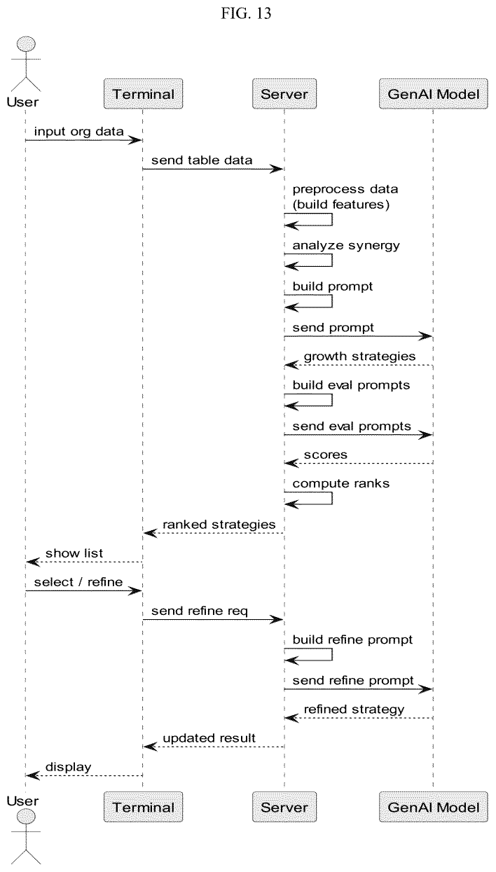

The following describes the processing flow using FIG. 13.

### Step 1:

The user operates the terminal to start a table-data processing program and to create or open a table containing organization-related data.
The user inputs values into rows and columns such as “Industry,” “Organization Size,” “Product / Service Characteristics,” and “Market Environment.”
The input of this step is manual key entries and edits performed on the table by the user, and the output of this step is a completed table-structured dataset stored in the terminal or in an associated storage service.

### Step 2:

The terminal transmits the table-structured dataset and associated metadata (such as sheet name, row range, and column labels) to the server via a network connection.
The terminal converts the internal table representation into a transferable format, such as a structured text file or a structured message body, attaches user identification information, and sends an electronic request to the server.
The input of this step is the table-structured dataset residing on the terminal, and the output of this step is a network message containing the dataset and metadata delivered to the server.

### Step 3:

The server receives the network message from the terminal and stores the raw table-structured dataset in memory.
The server parses the received data and reconstructs a tabular data structure that preserves row indices, column names, and cell values.
The input of this step is the serialized dataset arriving through the communication interface, and the output of this step is an internal tabular representation ready for preprocessing.

### Step 4:

The server performs preprocessing on the internal tabular data to generate preprocessed data.
The server detects missing values in each column and performs missing-value completion by applying rules such as replacing missing categorical fields with the most frequent category and replacing missing numerical fields with a median value.
The server detects outliers in numerical columns by computing statistics such as mean and standard deviation, and removes or caps records whose values exceed predetermined thresholds.
The server encodes categorical values by mapping each category to a numeric code or a vector representation, and performs numerical conversion and normalization on numerical fields to fit a predetermined numeric range.
The input of this step is the raw internal tabular representation, and the output of this step is a set of preprocessed feature vectors or tensors suitable for model input.

### Step 5:

The server generates feature vectors for organizations from the preprocessed data and stores them in a tensor data structure.
The server concatenates encoded categorical features, normalized numerical features, and optionally derived interaction features into a fixed-length vector for each organization.
The server arranges these vectors into one or more higher-dimensional tensors for batch processing by a neural network.
The input of this step is the preprocessed tabular data, and the output of this step is tensorized feature data representing organizations in a machine-readable numeric form.

### Step 6:

The server analyzes relationships and synergies among organizations by processing the tensorized feature data using an information processing model.
The server inputs the feature tensors into an encoder network, such as a neural network, and computes embedding vectors that represent each organization in a latent space.
The server calculates similarity or synergy scores between pairs or groups of embeddings, for example by computing dot products or cosine similarities, and constructs a matrix or graph structure describing potential synergies.
The input of this step is the tensorized feature data, and the output of this step is an embedding representation for each organization and a structure of relationship and synergy scores.

### Step 7:

The server generates a prompt sentence for a generative AI model based on the preprocessed data and the calculated relationships and synergies.
The server converts selected organization attributes and synergy summaries into natural language tokens and composes a descriptive text, such as: “The organization operates in the manufacturing industry, has a medium size, focuses on new product development, and faces a highly competitive market. Based on the following potential synergies with other organizations: [synergy summary], propose detailed growth strategies.”
The server may include identifiers corresponding to synergy clusters or embedding-based indicators within the prompt sentence to preserve technical details.
The input of this step is the preprocessed data and the relationship and synergy structure, and the output of this step is a prompt sentence in natural language prepared for the generative AI model.

### Step 8:

The server executes inference of a generative AI model using the prompt sentence and, optionally, the feature tensors.
The server tokenizes the prompt sentence into token IDs according to a tokenizer associated with a transformer-based generative AI model, and associates auxiliary tensors derived from feature vectors if used.
The server feeds the token IDs and auxiliary tensors into the generative AI model, performs forward propagation through multiple layers of attention and feed-forward sub-networks, and computes probability distributions over possible next tokens.
The server applies a decoding method such as beam search or nucleus sampling to generate multiple distinct sequences of tokens, and then converts the sequences back into human-readable text describing respective growth strategies.
The input of this step is the prompt sentence and model parameters with optional feature tensors, and the output of this step is a set of candidate growth strategies expressed as natural-language texts.

### Step 9:

The server prepares evaluation prompt sentences for each generated growth strategy to request quantitative evaluation.
The server embeds context information (industry, size, market environment) and the text of each strategy into a template such as: “Evaluate the following growth strategy for an organization in the manufacturing industry of medium size in a highly competitive market. Rate on a scale from 1 to 10 for (1) growth potential, (2) risk level, and (3) investment effect. Provide the three scores separated by commas. Strategy: [strategy text].”
The server creates one evaluation prompt sentence per strategy and stores them in association with the corresponding strategy texts.
The input of this step is the list of generated growth strategies and original organization context, and the output of this step is a list of evaluation prompt sentences paired with strategies.

### Step 10:

The server obtains numerical evaluation results for each strategy by inputting each evaluation prompt sentence and corresponding strategy text into a generative AI model or a separate evaluation model.
The server tokenizes the evaluation prompt sentence, performs forward propagation through an evaluation network, and constrains the output space to numeric tokens and separators to encourage structured numeric output.
The server receives the model output, parses the returned token sequence to extract individual scores for growth potential, risk level, and investment effect, and converts the tokens into numerical values.
The input of this step is a set of evaluation prompt sentences paired with strategy texts and the trained model parameters, and the output of this step is numerical evaluation results for each evaluation index of each strategy.

### Step 11:

The server calculates a comprehensive evaluation value for each growth strategy based on its numerical evaluation results.
The server applies a predetermined formula, for example a weighted sum or other aggregation function, to combine growth potential, risk level, and investment effect into a single scalar value per strategy.
The server uses vectorized arithmetic operations on arrays of scores to compute comprehensive evaluation values efficiently across all strategies.
The input of this step is the numerical evaluation results for all strategies, and the output of this step is a comprehensive evaluation value associated with each strategy.

### Step 12:

The server ranks the growth strategies based on their comprehensive evaluation values and constructs an ordered list.
The server applies a sorting algorithm to the list of strategies keyed by comprehensive evaluation value, assigns rank positions starting from the highest score, and stores rank information along with the strategies and detailed scores.
The server formats the ranked data into a structured response suitable for transmission to the terminal, including strategy text, scores, and rank.
The input of this step is the list of strategies with comprehensive evaluation values, and the output of this step is a ranked strategy list with associated metadata.

### Step 13:

The server transmits the ranked strategy list to the terminal, and the terminal receives and parses the response.
The terminal reconstructs the strategy texts, scores, and rank positions from the received data and prepares a layout for screen display.
The input of this step on the server side is the ranked strategy list, and the output of this step is a network response sent to the terminal; the input of this step on the terminal side is the received response, and the output of this step is an internal data structure ready for rendering.

### Step 14:

The terminal displays the ranked growth strategies to the user in a graphical user interface.
The terminal shows each strategy with its rank number, a brief excerpt, and evaluation scores, and provides user interface controls for selecting a strategy or requesting refinement.
The input of this step is the internal data structure containing ranked strategies and scores, and the output of this step is a rendered display screen that presents the information to the user.

### Step 15:

The user interacts with the displayed strategies by selecting one or more strategies and optionally entering additional instructions.
The user may, for example, select a high-ranking strategy and request a refinement such as “reduce risk” or “focus on a specific region,” by operating the terminal's input interface.
The input of this step is the displayed information on the terminal screen, and the output of this step is a user selection and optional text instructions representing a refinement request.

### Step 16:

The terminal sends the user's selection and refinement request to the server.
The terminal packages the selected strategy identifier and the user-specified instructions into a structured message and transmits the message over the network to the server.
The input of this step is the user's selection and text input captured by the terminal, and the output of this step is a refinement request message delivered to the server.

### Step 17:

The server generates a refinement prompt sentence based on the selected strategy, the original organization context, and the user's additional instructions.
The server composes a text such as: “Refine the following growth strategy to reduce risk while maintaining growth potential for a medium-sized manufacturing organization in a highly competitive market. Strategy: [strategy text].”
The server associates this refinement prompt with the original strategy text and prepares it for input to the generative AI model.
The input of this step is the selected strategy, the organization-related data, and the user's instructions, and the output of this step is a refinement prompt sentence.

### Step 18:

The server performs another generative AI inference using the refinement prompt sentence and original strategy text.
The server tokenizes the refinement prompt, feeds tokens into the generative AI model, and computes a revised strategy text using decoding procedures similar to those in the initial generation.
The server then may repeat evaluation, comprehensive scoring, and ranking for the revised strategy or integrate the revised strategy into the existing ranked list.
The input of this step is the refinement prompt sentence and model parameters, and the output of this step is at least one revised growth strategy, optionally accompanied by updated scores and rank.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented strategy support systems suffer from several technical limitations when handling complex, heterogeneous business data and generating actionable plans using a generative AI model. First, typical systems simply pass raw or lightly pre-processed tabular data to an external model or require a human operator to manually craft a prompt sentence, which leads to unstable output quality, dependence on operator skill, and inefficient utilization of computing resources. The processor in such systems does not systematically perform normalization, feature extraction, and structured summarization tailored for prompt generation, so the generative AI model often receives redundant or noisy context, causing increased latency, higher token consumption, and inconsistent plan generation.

Second, conventional systems rarely integrate an automated evaluation pipeline into the same processor. Even where a generative AI model can propose growth plans or operation plans, the processor typically does not automatically invoke the model (or a separate evaluation model) with evaluation-specific prompt sentences, extract structured scores, and compute composite evaluation values. As a result, ranking of multiple candidate plans is often performed manually or via simplistic scoring scripts that are not tightly coupled to the generative AI analysis, leading to poor scalability and limited reproducibility in large-scale deployments.

Third, existing systems do not effectively incorporate user interaction data and user emotional state into the core computational workflow. While some interfaces allow users to provide feedback, the processor generally treats such feedback as an external, non-integrated signal. Moreover, conventional systems lack a mechanism for acquiring image and audio information from a terminal device, performing machine-based emotion recognition, and feeding the resulting emotion information back into the prompt sentences. Consequently, the generative AI model cannot dynamically adapt plan generation or adjustment to a user's actual emotional state, which limits personalization and can degrade decision-support quality.

Fourth, in logistics and other operation-intensive domains, typical systems treat logistics operation information (such as transportation, inventory, and warehousing data) as just another data source without domain-specific prompt construction or evaluation logic. The processor often applies generic reporting or rule-based optimization instead of using a generative AI model with operation-specific prompt sentences and ranking logic. This results in sub-optimal utilization of the model's generative and reasoning capabilities for route design, method selection, or operation scheme optimization.

Accordingly, there is a need for an improved computer-implemented system in which a processor (i) programmatically transforms organization information and operation information into model-ready features and dynamically constructed prompt sentences, (ii) orchestrates both generation and evaluation of multiple plans via a generative AI model or a separate evaluation model, (iii) automatically computes composite evaluation values and ranks the plans, and (iv) acquires and uses user emotion information to condition the prompt sentences and thereby adapt plan generation or adjustment. Such a system improves the functioning of the computer itself by reducing manual prompt engineering, structuring model interaction, and enabling a closed feedback loop between data processing, model invocation, evaluation, ranking, and emotion-aware adaptation.

The specific processing by the specific processing unit 290 of the data processing device 12 in Application Example 2 is realized by the following means.

The present invention provides a server comprising a processor configured to receive and store a data set including organization information and operation information, execute normalization and feature-value calculation on the stored data set, and generate summary information of the data set; to dynamically construct, based on the feature-processed data set and the summary information, a prompt sentence that instructs a generative AI model to analyze the data set and to generate a plurality of growth plans or operation plans, and to input the constructed prompt sentence to the generative AI model so as to acquire response information from the generative AI model and extract and store the plurality of plans in a plan storage area; to generate, for each stored plan, an evaluation-oriented prompt sentence and input the evaluation-oriented prompt sentence to the generative AI model or to a separate evaluation model in order to acquire numerical evaluation values and associated reasoning for a plurality of evaluation indices, to compute a composite evaluation value for each plan based on the numerical evaluation values, and to rank the plurality of plans according to the composite evaluation values to produce ranking data; to control communication with a terminal device by transmitting the ranked plans to the terminal device and by receiving and storing user evaluation information and selection information from the terminal device; and to perform emotion-recognition processing on image information and audio information acquired from the terminal device or from an external device to obtain emotion information indicating a user emotion state, and to include the emotion information in a prompt sentence to be input to the generative AI model so that the generative AI model generates or adjusts the growth plans or the operation plans in accordance with the user emotion state. This enables the computer system to automatically transform heterogeneous business and logistics data into optimized prompt sentences, to systematically generate, evaluate, and rank multiple plans through structured interaction with a generative AI model, and to adapt the generated plans based on user emotion, thereby improving the efficiency, consistency, and personalization of computer-implemented decision support.

The term “processor” refers to a hardware or virtual information-processing element, such as a central processing unit or execution core, configured to execute instructions that perform the data acquisition, transformation, model interaction, evaluation, ranking, control, and emotion-recognition operations described herein.

The term “storage device” refers to a physical or logical data-storage subsystem, such as a magnetic disk, solid-state memory, or network-attached storage, that is configured to store data sets, feature values, plans, evaluation results, and other information used by the processor.

The term “data set” refers to a collection of structured or semi-structured data records including at least organization information and/or operation information, which are used as input for analysis, plan generation, and evaluation by the processor and a generative AI model.

The term “organization information” refers to data describing characteristics of an entity such as a business or institution, including at least one of industry classification, scale, offered products or services, market environment, revenue, resources, or other operational attributes.

The term “enterprise information” refers to a subset of organization information specifically relating to a commercial business entity, including business domain, size, financial indicators, and market conditions.

The term “operation information” refers to data describing the execution of activities of an organization, including at least one of process records, resource usage, scheduling information, performance indicators, or other operational metrics.

The term “logistics operation information” refers to operation information related to logistics activities, including at least transportation information, inventory information, and warehousing or inbound/outbound information associated with movement and storage of goods.

The term “transportation information” refers to data describing the movement of items between locations, including at least routes, distances, times, shipment identifiers, and transportation modes.

The term “inventory information” refers to data describing quantities, locations, and statuses of stored items, including at least stock levels, item identifiers, and storage positions.

The term “warehousing information” refers to data describing storage and handling operations in facilities, including at least inbound records, outbound records, picking, packing, and storage slot utilization.

The term “normalization processing” refers to processing that converts raw data values into standardized representations, including at least scaling, encoding, cleaning, and format unification so that the data is suitable for subsequent feature calculation and model input.

The term “feature-value calculation” refers to processing that derives numerical or categorical feature values from raw or normalized data, including at least computed ratios, aggregated metrics, or domain-specific indicators used as inputs to analysis or models.

The term “summary information” refers to data that compactly represents a larger data set, including at least statistical aggregates, textual descriptions, or reduced tables that describe main characteristics of organization information or operation information.

The term “template information” refers to predefined text structures or patterns used as a basis for constructing a prompt sentence, where variable portions are filled with summary information or feature data.

The term “prompt sentence” refers to a text instruction, including optional embedded data, provided to a generative AI model or evaluation model to specify a task such as analysis, plan generation, or evaluation.

The term “generative AI model” refers to a trained information-processing model that receives a prompt sentence and optionally structured data as input, and outputs generated information such as analyses, plans, or evaluations using machine-learning techniques.

The term “evaluation model” refers to an information-processing model, which may be a generative AI model or a distinct machine-learning model, configured to receive an evaluation-oriented prompt or structured data and to output evaluation results such as scores and reasoning.

The term “growth plan” refers to a plan describing actions for expanding or improving an organization's activities, including at least strategies for market expansion, product development, or collaboration to increase performance indicators.

The term “operation plan” refers to a plan describing actions for improving or redesigning operational processes, including at least logistics routes, methods, or schemes for enhancing efficiency, cost, or service quality.

The term “plan storage area” refers to a logical or physical portion of a storage device allocated to store generated plans, associated metadata, evaluation values, and ranking information.

The term “evaluation indices” refers to a set of criteria used to assess a plan, including at least growth potential, risk level, resource-investment efficiency, feasibility, or other quantitative or qualitative measures.

The term “growth potential” refers to an evaluation index indicating the expected capability of a plan to improve or expand organizational performance metrics over a given time horizon.

The term “risk level” refers to an evaluation index indicating the likelihood and impact of adverse outcomes associated with implementing a plan.

The term “resource-investment efficiency” refers to an evaluation index indicating the relationship between required inputs such as cost or resources and expected benefits produced by a plan.

The term “feasibility” refers to an evaluation index indicating the practicality of implementing a plan, considering constraints such as resources, time, and existing infrastructure.

The term “numerical evaluation value” refers to a numeric score assigned to a plan for at least one evaluation index, which can be used for comparison, aggregation, and ranking.

The term “composite evaluation value” refers to a single aggregated metric computed from multiple numerical evaluation values using a predetermined combination rule, such as weighting or normalization, to represent overall plan quality.

The term “ranking data” refers to information indicating an order of multiple plans based on composite evaluation values or other criteria, including at least rank positions and identifiers of corresponding plans.

The term “terminal device” refers to an information-processing apparatus used by a user, such as a portable computing device or display device, which is configured to send operation information to the server and to receive and present plans and evaluation results.

The term “user operation information” refers to control or interaction data generated by a user through a terminal device, including at least requests for data, navigation actions, or instructions to display or update plan information.

The term “user evaluation information” refers to data representing a user's assessment of one or more plans, including at least ratings, comments, or qualitative feedback provided via a terminal device.

The term “selection information” refers to data indicating that a user has selected, approved, rejected, or otherwise designated one or more plans for further consideration or implementation.

The term “image information” refers to digital visual data, including at least still images or moving images capturing a user's face or body for analysis by an emotion-recognition process.

The term “audio information” refers to digital sound data, including at least speech or vocal sounds produced by a user, for analysis by an emotion-recognition process.

The term “emotion-recognition process” refers to processing that analyzes image information and/or audio information using pattern-recognition or machine-learning techniques to infer a user emotion state.

The term “emotion information” refers to data indicating a user emotion state derived from the emotion-recognition process, including at least emotion categories, intensity values, and associated confidence measures.

The term “user emotion state” refers to a condition of a user's affective status, such as joy, sadness, anger, surprise, or neutrality, as inferred by the emotion-recognition process.

The term “emotion-aware plan generation” refers to a process in which emotion information is incorporated into a prompt sentence or evaluation context so that the generative AI model generates or adjusts a plan differently depending on the user emotion state.

The term “delivery route” refers to a sequence of locations, times, and movements used for transporting items in a logistics operation.

The term “delivery method” refers to a set of operational parameters for transporting items, including at least transportation mode, scheduling pattern, and handling procedures.

The term “logistics operation scheme” refers to an arrangement of logistics resources and processes, including at least facility roles, routing structures, and service policies for operating a logistics system.

The term “spreadsheet-processing function” refers to an information-processing capability for managing tabular data, including at least input, editing, calculation, and storage of records in a table format.

The term “file created by an information-processing means having a spreadsheet-processing function” refers to a data file generated by a system or application that provides spreadsheet-processing capabilities, the file containing table-structured data suitable for extraction as a data set.

In one embodiment, a system includes a server, one or more terminal devices, and a network connecting them. The server includes at least one processor, a main memory, and a non-volatile storage device. The terminal includes at least one processor, a display device, an input device, and optionally a camera and a microphone. The server executes program modules that implement data preprocessing, prompt sentence construction, generative AI model interaction, plan evaluation and ranking, and emotion-aware adaptation.

Server uses a combination of hardware and software to implement the claimed functions. Server uses a central processing unit or an execution core as the processor, volatile memory as working memory, and a storage device such as a solid-state drive or a disk device as persistent storage. Server runs an operating system, a database management system, and an application stack including a scripting runtime environment (for example, a runtime for a high-level programming language), a numerical computation library (for example, a matrix and vector computation library), and a deep learning framework (for example, a tensor computation and automatic differentiation framework). Server also uses a network communication stack to exchange data with terminal devices and external AI services.

Server stores organization information and operation information in a structured database. Server receives a file created by an information-processing means having a spreadsheet-processing function, for example a tabular data file describing organizations, enterprises, and logistics operations. The file may be in a comma-separated values format or a similar structured text format. Server parses the file and stores each record as rows in relational tables, such as an organization table, an operation table, and a logistics table. Server stores indices on key attributes, such as organization identifier, time stamp, and route identifier, to enable efficient queries.

Server performs normalization processing and feature-value calculation on the stored data. Server uses a numerical computation library to convert raw categorical values into encoded vectors, to scale numerical values into normalized ranges, and to remove or impute missing values. For example, server converts industry categories into one-hot encoded vectors, scales revenue data to zero-mean and unit-variance values, and transforms time series of deliveries into fixed-length feature vectors such as average delivery time, variance of delay, and peak load indicators. Server writes these computed feature values into feature tables, each row including a foreign key to the original entity and a vector representation of features.

Server generates summary information that compactly represents large data sets. Server uses aggregation queries to compute statistical summaries, such as mean, median, maximum, and minimum values for key metrics. Server also generates textual summaries by mapping feature values and aggregates into natural language templates. For example, server constructs a sentence such as “Organization A operates in the manufacturing sector, has medium scale, and shows high revenue growth in the last year,” by combining structured attributes with template phrases.

Server constructs a prompt sentence for a generative AI model based on the feature-processed data and the summary information. Server maintains template information as parameterized text fragments for different tasks, such as synergy analysis, growth plan generation, and logistics optimization. Server selects an appropriate template according to the type of data and task. Server embeds summary information and key feature values into the template. For example, server constructs a prompt sentence such as:

“Based on the following organization information, propose growth strategies that maximize synergy. Organization A: industry=manufacturing, scale=medium, key products=X, Y. Organization B: industry=logistics services, scale=large, key services=warehousing, last-mile delivery. Consider market environment and potential collaboration, and return a numbered list of strategies with expected growth, risk level, and required investment.”

Server can also generate logistics-specific prompt sentences. For example, server constructs a prompt sentence such as:

“Based on the following delivery data, propose the optimal delivery routes and new delivery methods for this logistics facility. Route 1: average distance=40 km, on-time rate=92%, average delay=10 minutes. Route 2: average distance=15 km, on-time rate=85%, average delay=18 minutes. Consider cost, delivery time, and service level, and explain your reasoning briefly.”

Server sends the constructed prompt sentence to a generative AI model. In one embodiment, server uses a generative AI model implemented as a neural network model with an encoder-decoder or transformer architecture. The model includes multiple layers of self-attention blocks, feed-forward networks, and normalization layers. The model is trained on tokenized text sequences using a language modeling objective. During training, the model minimizes a loss function such as cross-entropy between predicted token distributions and ground-truth tokens. The model's parameters are updated using a gradient-based optimization algorithm and backpropagation through time.

Server interacts with the generative AI model via an application programming interface. Server converts the prompt sentence into a token sequence, transmits the token sequence to the model, and receives an output token sequence that represents generated text. Server reconstructs the generated text and parses it into structured plans. For example, server uses pattern recognition to detect numbered list items and headings and splits the text into separate plan entries.

Server extracts a plurality of growth plans or operation plans from the output and stores each plan, together with metadata such as source prompt, generation time, and model configuration, in a plan storage area. The plan storage area is a logical portion of the storage device used to maintain a history of generated plans and their associated evaluation results.

Server evaluates each generated plan using evaluation-oriented prompt sentences and, optionally, a separate evaluation model. Server generates an evaluation prompt sentence for each plan, combining the plan content, original context, and explicit evaluation questions. For example, server constructs a prompt sentence such as:

“Evaluate the following growth strategy on a scale of 1 to 10 for growth potential, risk level, resource-investment efficiency, and feasibility. Provide a JSON-like text with fields: growth_potential, risk_level, resource_efficiency, feasibility, and a brief reasoning for each score. Strategy: [full text of the strategy].”

Server inputs the evaluation prompt sentence into the generative AI model or an evaluation-specialized model and receives a structured evaluation output. Server parses the output to extract numerical evaluation values and textual reasoning. Server normalizes the scores if needed and stores them in an evaluation table linked to the corresponding plan.

Server computes a composite evaluation value for each plan by applying a predetermined combination rule to the individual scores. For example, server uses a weighted sum where growth potential and resource-investment efficiency receive higher weights and risk level receives an inversely proportional contribution. Server can iteratively adjust the weights based on historical acceptance of plans, thereby improving ranking behavior over time.

Server ranks the plans according to the composite evaluation values. Server sorts the plans, assigns rank positions, and stores ranking data in a ranking table. The ranking process uses efficient sorting algorithms and indices to maintain performance for large numbers of plans.

Server communicates the ranked plans to terminal devices. Server receives user operation information from a terminal, such as a request to display top N plans for a given organization or logistics facility. Server retrieves the corresponding ranked plans and transmits them as structured response data. Terminal receives the data and displays each plan's content, evaluation scores, and rank on a user interface.

Terminal uses a display device and an input device to present and capture user interactions. Terminal may execute a client application implemented using a cross-platform user interface framework. Terminal parses the received data and presents it as a selectable list or grid of plans. Terminal allows the user to open a plan and view detailed reasoning, evaluation scores, and associated logistics metrics.

User interacts with the terminal to provide user evaluation information and selection information. User can assign additional ratings, annotate plans with comments, or mark plans as preferred or rejected. Terminal sends this information back to the server. Server records these user evaluations and selections in the storage device.

Server optionally acquires image information and audio information from the terminal or from an external device for emotion recognition. Terminal uses the camera and microphone to capture a user's face and voice while the user browses and evaluates plans. Terminal periodically transmits frames and audio segments to the server or to an associated emotion-recognition module.

Server performs an emotion-recognition process on the received image and audio data. In one embodiment, server uses a convolutional neural network for image-based emotion recognition and a recurrent or transformer-based model for audio-based emotion recognition. The image model receives frames as input, extracts spatial features through successive convolutional and pooling layers, and maps them to emotion probabilities via fully connected layers and a softmax output. The audio model receives spectrogram representations, processes them with temporal convolution or recurrent units, and outputs emotion probabilities. Server combines the outputs of the image and audio models to form emotion information that characterizes the user emotion state with categories (such as joy, sadness, anger, surprise) and intensity levels.

Server incorporates the emotion information into subsequent prompt sentences. For example, server modifies a growth plan prompt sentence as follows:

“The user is currently showing a joyful emotion with high confidence. Based on this emotional state and the following organization information, propose growth strategies that are ambitious but maintain moderate risk. [organization summaries]”

Similarly, server may construct a product recommendation prompt, for example:

“The customer is showing a surprised emotion. Based on this emotion and the product catalog below, generate a proposal for the latest gadget that emphasizes innovative features and impressive sound quality.”

By including emotion information in the prompt sentence, server causes the generative AI model to condition its generation on the user's affective context. This yields emotion-aware plans that are more likely to match the user's preferences and acceptance threshold.

Server implements a specific data flow and module structure that improves technical performance compared with naive usage of AI services. Server limits the size of prompt sentences by using feature-based summaries instead of raw tables, thereby reducing communication load, token count, and latency. Server manages a cache of previous plan evaluations and uses them to avoid re-evaluating identical or similar plans. Server uses indexing structures in the storage device to perform fast retrieval of relevant data segments when constructing prompt sentences, which further reduces response time.

This architecture provides technical improvements over manual prompt crafting and ad hoc AI integration. Server programmatically constructs prompt sentences based on normalized feature vectors and structured summaries, ensuring that the generative AI model receives consistent, noise-reduced input. As a result, the model's outputs are more stable and interpretable, and the system achieves better reproducibility and accuracy of generated plans. Server's automated evaluation and ranking pipeline reduces the need for manual scoring and mitigates human inconsistency, while the use of composite evaluation values enhances decision quality.

In one alternative embodiment, server uses a locally hosted generative model instead of a remote model. Server executes a transformer-based model stored on the storage device and loaded into main memory. Server uses hardware acceleration, such as a graphics processing unit or tensor accelerator, to compute self-attention and feed-forward layers efficiently. In this configuration, server controls the full data path from tokenization through decoding, which allows further optimizations such as custom beam search parameters, vocabulary pruning, and quantized weights to reduce memory footprint and increase throughput.

In another embodiment, server employs a separate evaluation model that is trained specifically on plan evaluation tasks. This evaluation model may use a smaller architecture with fewer layers, optimized for extracting numerical scores from plans and context. Server routes generation prompts to a larger model and evaluation prompts to the smaller model. This division of labor reduces computation time and improves overall throughput.

In a further embodiment, server applies rule-based pre-filtering and post-processing in combination with the generative AI model. Server may implement non-conventional rules that remove plans violating hard constraints, such as maximum available resources or regulatory requirements, before proceeding to evaluation. Server thus avoids unnecessary evaluation of infeasible plans and focuses computational resources on promising candidates.

The described system is not limited to business strategy scenarios. Server can use the same mechanisms for other operation optimization tasks, for example, configuring industrial processes or scheduling maintenance operations. In such cases, operation information represents process parameters, sensor readings, and maintenance logs, and server constructs prompt sentences tailored to these domains. The technical advantages remain: reduced communication overhead, structured model interaction, automated evaluation and ranking, and emotion-aware personalization where applicable.

By integrating normalization, feature-value calculation, structured prompt sentence construction, generative AI model interaction, automated evaluation and ranking, and emotion-recognition feedback into a unified server-controlled pipeline, the system improves the functioning of the computer itself. Server uses specific data structures, model architectures, and processing steps that yield faster response times, reduced token usage, more accurate and consistent plan generation, and adaptive behavior that cannot be realized by manual human work alone.

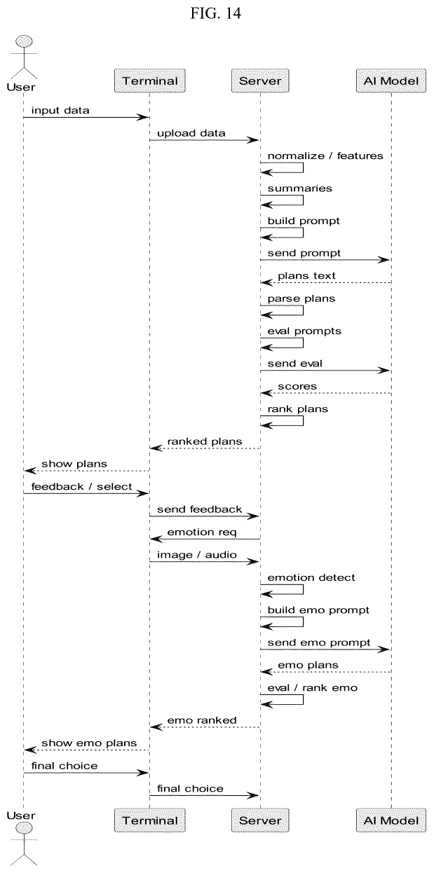

The following describes the processing flow using FIG. 14.

### Step 1:

Server receives and stores source data.
Server receives, as input, one or more files created by an information-processing means having a spreadsheet-processing function, such as tabular files containing organization information or logistics operation information. Server parses the files, validates the data format, and converts rows into internal records. Server performs basic type checking, removes obviously invalid records, and assigns internal identifiers. Server writes the cleaned records into relational tables in a storage device (for example, an organization table, an operation table, and a logistics table). The output of this step is a set of normalized database records linked to the original files.

### Step 2:

Server performs normalization and feature-value calculation.
Server reads, as input, the stored records for organizations and operations from the database. Server applies normalization processing, such as scaling numerical attributes (for example, revenue, number of employees, delivery times) to standardized ranges, and encoding categorical attributes (for example, industry type, region, transportation mode) into numeric or symbolic feature codes. Server then computes feature values, such as revenue per employee, variance of delivery delay, route utilization rate, and inventory turnover. Server uses numerical computation libraries to perform arithmetic operations, aggregations, and vector transformations on the input fields. Server stores the resulting feature vectors and derived metrics back into feature tables. The output of this step is a structured set of feature records associated with each organization or operation entity.

### Step 3:

Server generates summary information.
Server retrieves, as input, the feature records and base records from the database. Server executes aggregation queries to compute statistical summaries (for example, averages, maxima, minima) for each organization or route. Server then maps these statistics into concise text descriptions by inserting values into pre-defined natural language templates, such as “Organization X operates in sector Y with medium scale and high recent growth,” or “Route R has an average distance of D, on-time rate P, and average delay T.” Server concatenates these sentences per entity to form summary information. Server stores the summaries as text blobs linked to the corresponding entities. The output of this step is a set of textual summaries representing the essential characteristics of the input data.

### Step 4:

Server constructs a task-specific prompt sentence.
Server receives, as input, the feature records, summary information, and a task specification (for example, growth plan generation or logistics optimization). Server selects a template for the prompt sentence based on the task type. Server then embeds summary sentences and key numeric values into the template, forming a prompt sentence that describes the context and instructs the generative AI model what to do. For example, server may construct:

“Based on the following organization information, propose growth strategies that maximize synergy. Organization A: industry=manufacturing, scale=medium, key products=X, Y. Organization B: industry=logistics services, scale=large, key services=warehousing, last-mile delivery. Consider market environment and potential collaboration, and return a numbered list of strategies with expected growth, risk level, and required investment.”
Server outputs a completed prompt sentence ready to be sent to the generative AI model.

### Step 5:

Server sends the prompt sentence to the generative AI model and receives generated plans.
Server uses, as input, the constructed prompt sentence and model configuration parameters (for example, temperature, maximum output length). Server tokenizes the prompt sentence and submits the token sequence to the generative AI model via an application programming interface. Server waits for the model to perform internal computations and then receives an output token sequence.
Server decodes the output tokens into text and parses the text to identify multiple plans, for example by splitting at numbered list markers or headings. Server stores each identified growth plan or operation plan together with context metadata in a plan storage area of the database. The output of this step is a set of discrete generated plans linked to their originating prompt sentence.

### Step 6:

Server generates evaluation-oriented prompt sentences for each plan.
Server reads, as input, each stored plan and its associated context (such as organization information or logistics data). For each plan, server constructs an evaluation-oriented prompt sentence that instructs the generative AI model or a separate evaluation model to assess the plan. For example, server may generate:

“Evaluate the following growth strategy on a scale of 1 to 10 for growth potential, risk level, resource-investment efficiency, and feasibility. Return scores and brief reasoning for each item. Strategy: [plan text].”
Server aggregates these evaluation prompts in an internal queue or batch. The output of this step is a collection of evaluation prompt sentences associated with corresponding plans.

### Step 7:

Server performs model-based evaluation and extracts numerical scores.
Server sends, as input, each evaluation prompt sentence to the generative AI model or a specialized evaluation model via the same or a separate interface. Server receives evaluation text that includes numerical ratings and explanation sentences. Server then parses the evaluation text to extract numeric values for each evaluation index (for example, converting “growth potential: 8/10” into an integer value 8). Server validates the parsed values, normalizes them to a common scale if needed, and writes them into an evaluation table, associating each score set with the corresponding plan identifier. The output of this step is a structured set of numerical evaluation values and reasoning texts for each plan.

### Step 8:

Server computes composite evaluation values and ranks the plans.
Server reads, as input, the numerical evaluation values stored for each plan. Server applies a composite scoring formula, such as a weighted sum or weighted average of the indices, where weights are predefined or learned from historical user decisions. Server multiplies each score by its corresponding weight, sums the results, and optionally applies normalization to create a composite evaluation value per plan. Server then sorts the plans by composite value in descending or ascending order, assigns rank numbers, and stores the ranking information in a ranking table. The output of this step is a ranking result that orders all candidate plans by their computed quality.

### Step 9:

Terminal requests and displays ranked plans to the user.
Terminal sends, as input, a request message to the server that includes user identification, target organization or logistics facility, and a limit on the number of plans to retrieve. Terminal receives, as output from the server, a structured response containing plan texts, individual evaluation scores, composite evaluation values, and rank information. Terminal parses this response and renders it on a display device, for example as a list where each entry shows a plan title, summary, scores, and rank.

Terminal allows the user to select a plan for detailed viewing, which triggers additional display of the plan's full text and reasoning.

### Step 10:

User reviews, evaluates, and selects plans.
User receives, as input, the visual representation of ranked plans on the terminal screen. User examines the content, scrolls through entries, and opens detailed views as needed. User then operates input controls (such as buttons, sliders, or text fields) to provide additional ratings, comments, and selection signals, for example marking a plan as “preferred” or “rejected.” User's actions result in user evaluation information and selection information, which terminal encodes as structured data and transmits back to the server. The output of this step is user-generated feedback data associated with specific plan identifiers.

### Step 11:

Server records user feedback and optionally updates weighting or templates.
Server receives, as input, user evaluation information and selection information from the terminal.
Server stores these data in feedback tables linked to plan identifiers and user identifiers. Server periodically analyzes accumulated feedback to adjust internal parameters, such as the weights used in composite evaluation or the phrasing of certain prompt templates. Server may compute statistics, such as the correlation between model scores and user selections, and uses these statistics to refine future evaluation formulas or prompt constructions. The output of this step is an updated configuration that reflects real user preferences and improves subsequent plan ranking.

### Step 12:

Terminal captures image and audio data for emotion recognition.
Terminal obtains, as input, real-time sensor data from a camera and a microphone while the user views and interacts with plans. Terminal samples video frames of the user's face and audio segments of the user's voice at predefined intervals. Terminal preprocesses the data, for example by resizing images or converting audio into compressed formats, and transmits the processed samples to the server or to an associated emotion-recognition service. The output of this step is a stream of image and audio data packets tagged with timestamps and context (such as which plan is currently displayed).

### Step 13:

Server performs emotion-recognition processing and generates emotion information.
Server receives, as input, the image and audio data packets from the terminal. Server applies, in sequence, an image-based emotion classifier and an audio-based emotion classifier. Server converts each image frame into feature maps using convolutional layers, then maps the features to emotion class probabilities. Server converts each audio segment into a spectrogram or other time-frequency representation, then processes it with a temporal model (for example, recurrent or attention layers) to obtain emotion probabilities. Server combines the image-based and audio-based probabilities, for example by weighted averaging, to produce emotion information describing the current user emotion state. Server stores the emotion label (such as joy, surprise, or neutrality), intensity values, and confidence scores in an emotion log table. The output of this step is emotion information associated with user activity and time.

### Step 14:

Server incorporates emotion information into new prompt sentences.
Server reads, as input, the latest emotion information for a given user or session together with context data (organization information, operation information, or product catalog). Server modifies the task-specific template to include an explicit description of the user emotion state. For example, server constructs a prompt sentence such as:

“The user is currently showing joy with high confidence. Based on this emotional state and the following organization information, propose growth strategies that are ambitious but maintain moderate risk.”
or

“The customer is showing a surprised emotion. Based on this emotion and the product catalog below, generate a proposal for the latest gadget that emphasizes innovative features and impressive sound quality.”
Server thus outputs emotion-aware prompt sentences that condition the generative AI model on both data context and affective context.

### Step 15:

Server regenerates or adjusts plans using emotion-aware prompt sentences.
Server uses, as input, the emotion-aware prompt sentences created in the previous step. Server sends these prompt sentences to the generative AI model, receives generated text, and parses it into new or adjusted plans. Server may treat these as separate plan entries or as revisions of existing plans, storing links to the original plans and the associated emotion states. Server can re-evaluate and re-rank these plans using the same evaluation pipeline, optionally with adjustments (for example, favoring plans generated under positive emotion states). The output of this step is a set of emotion-adapted plans and updated rankings ready to be delivered to the terminal.

### Step 16:

User reviews emotion-adapted plans and finalizes decisions.
User receives, as input, the emotion-adapted ranked plans displayed on the terminal. User compares these plans with previous versions, noting differences in tone, risk profile, or recommended actions.
User then selects one or more final plans for implementation by operating the terminal's input controls. Terminal sends the final selection information to the server. User's choice concludes the decision process, and the output of this step is a final set of adopted plans along with their technical evaluation, ranking, and associated emotion context, all stored by the server for future reference and system refinement.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

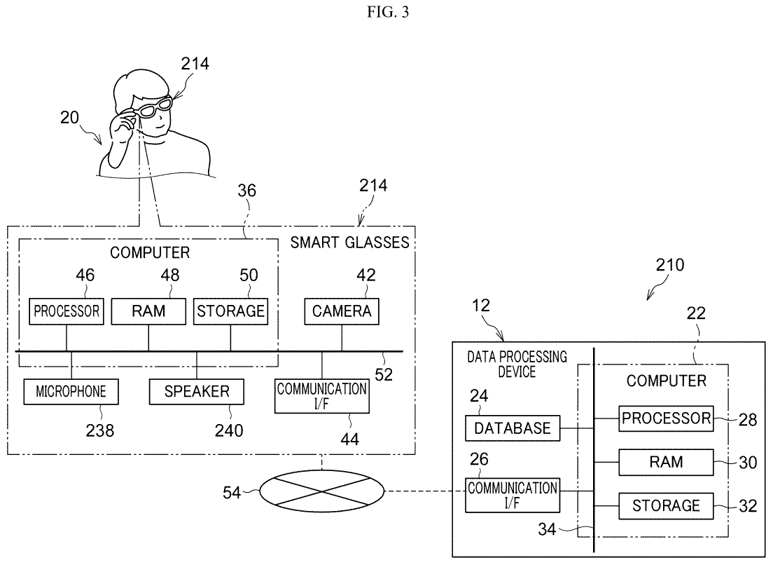

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

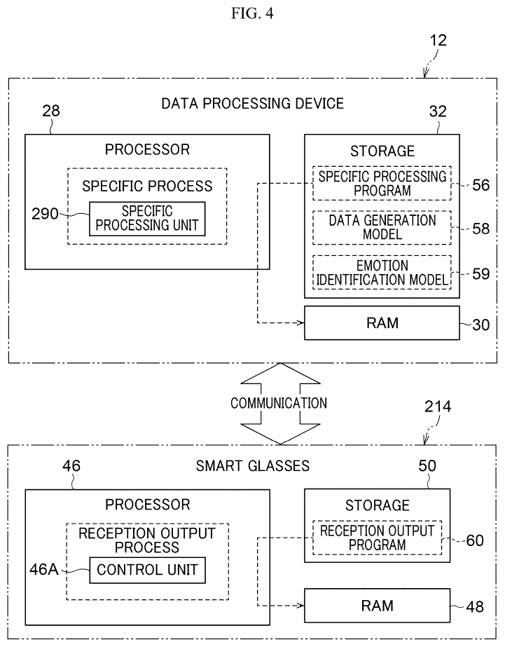

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

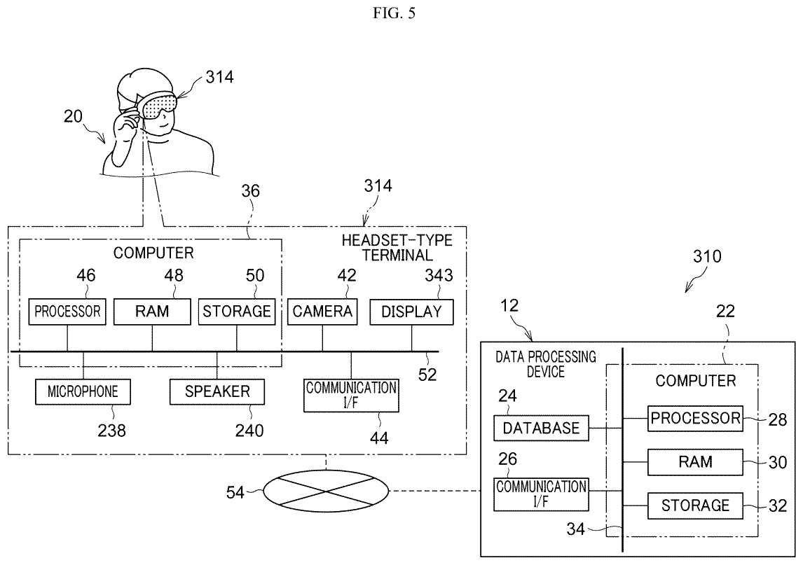

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

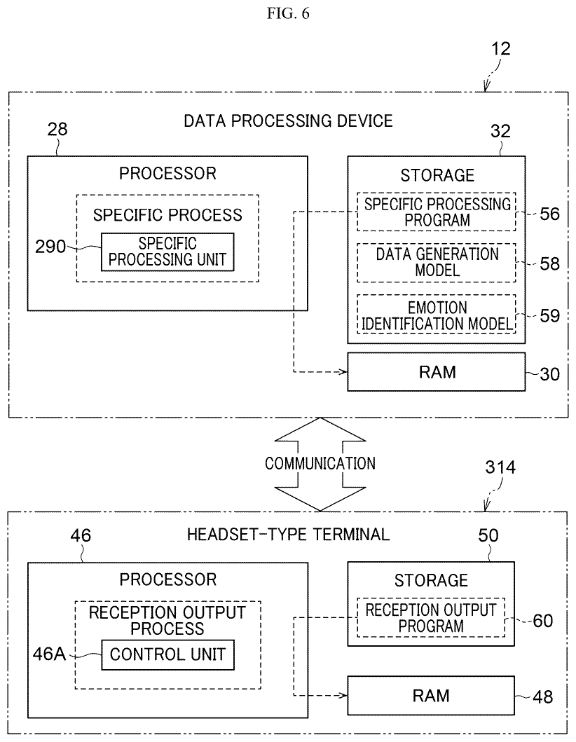

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

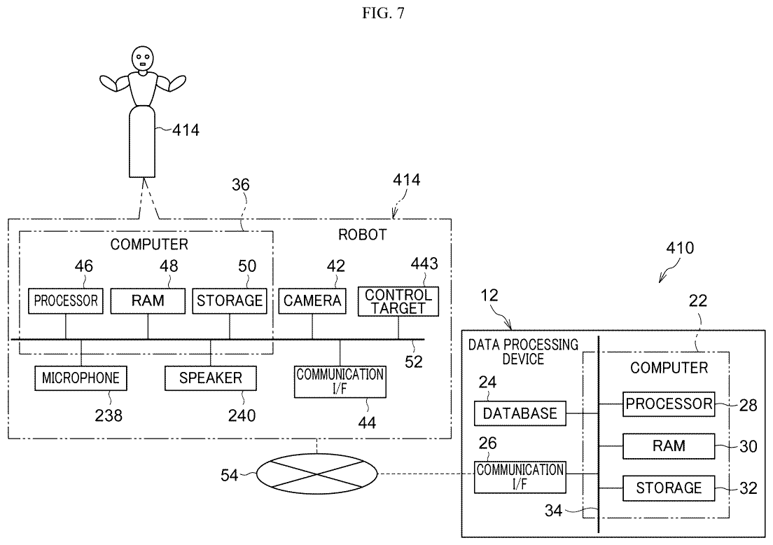

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

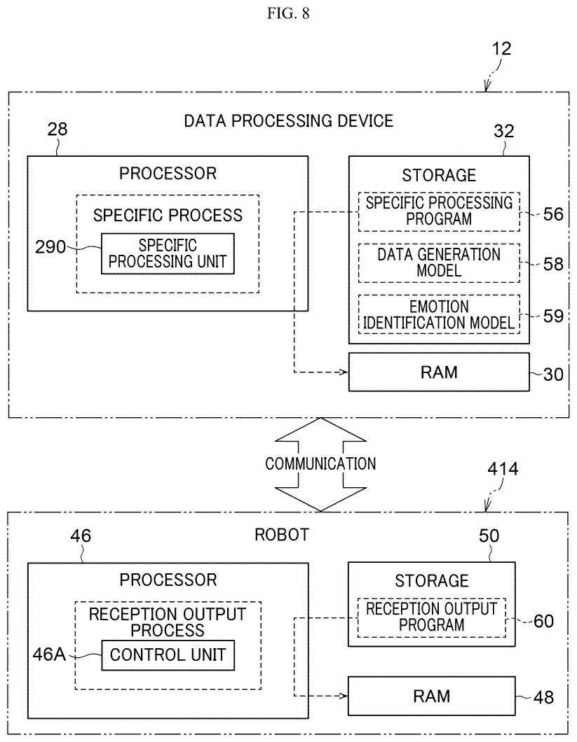

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

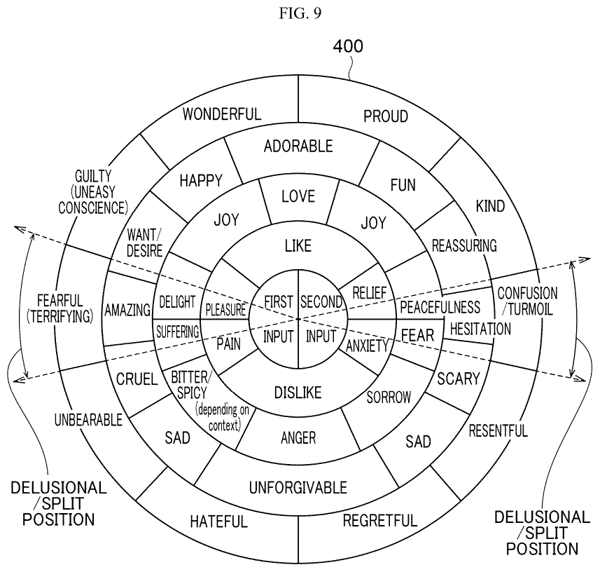

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

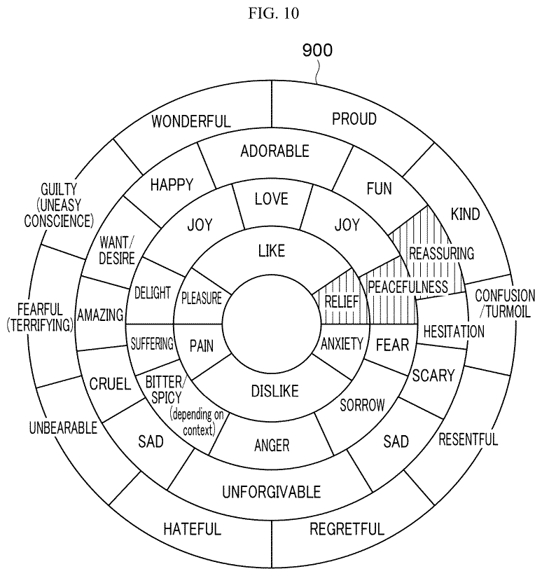

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
cause a terminal device to accept input of organization information by using a tabular data processing program and to cause the terminal device to transmit the organization information as machine-readable data to an information processing apparatus,
convert the machine-readable data into analysis data by performing preprocessing including complementing missing information, converting attribute information into numerical information, and normalizing the numerical information,
execute a generative AI model by using the preprocessed analysis data and a prompt sentence input by a user, and generate analysis result data including indicators representing synergy between a plurality of organizations,
generate, on the basis of the analysis result data and the prompt sentence, a plurality of text-based growth strategy candidates that utilize the synergy between the plurality of organizations,
calculate, for each of the growth strategy candidates, evaluation indices representing growth potential, risk level, investment effectiveness, and feasibility, and assign a self-evaluation score to each of the growth strategy candidates on the basis of the evaluation indices, and
rank the plurality of growth strategy candidates in order of priority on the basis of the self-evaluation scores and output a ranking result to the terminal device.

### Supplementary 2

The system according to supplementary 1,
wherein the processor is configured to
cause the terminal device to present the ranked growth strategy candidates, and to output verification information to the terminal device so that the user views the ranked growth strategy candidates and selects at least one of the ranked growth strategy candidates as an adoption candidate.

### Supplementary 3

The system according to supplementary 1,
wherein the processor is configured to
store the preprocessed analysis data and the analysis result data of the generative AI model in a storage device in a form reusable for generation of the growth strategy candidates and calculation of the self-evaluation scores, and, when the same or a different prompt sentence is input, generate additional growth strategy candidates and rank the additional growth strategy candidates by using the stored data.

### Application Example 1

### Supplementary 1

A system comprising a processor,
wherein the processor is configured to
acquire attribute information regarding a plurality of organizations, read the attribute information from an electronic file in which the attribute information is stored as tabular data, and perform preprocessing including missing-value completion, format unification, and normalization of categorical values on the attribute information to convert the attribute information into structured data that is analyzable,
summarize the structured data and generate a prompt sentence for instructing a generative artificial intelligence model to analyze synergistic effects among the plurality of organizations based on the structured data,
input the prompt sentence into the generative artificial intelligence model, cause the generative artificial intelligence model to analyze the structured data, and obtain an analysis result regarding synergistic effects in combinations of technologies and products of the plurality of organizations, generate, based on the analysis result regarding the synergistic effects, a prompt sentence for instructing the generative artificial intelligence model to generate a plurality of candidate business growth plans, input the prompt sentence into the generative artificial intelligence model, and obtain the business growth plans including a plurality of candidate production process configurations that combine technologies and products of different organizations,
generate, for each of the generated business growth plans, a prompt sentence for instructing the generative artificial intelligence model to perform a self-evaluation process including evaluation criteria regarding productivity improvement, cost efficiency, implementation difficulty, and risk, input the prompt sentence into the generative artificial intelligence model, and obtain numerical evaluation values and evaluation reasons for the business growth plans from the generative artificial intelligence model,
rank the plurality of business growth plans based on the numerical evaluation values and generate a priority list of candidate production process configurations including a result of the ranking, and output the priority list to an external apparatus.

### Supplementary 2

The system according to supplementary 1,
wherein the processor is configured to
control a display device to display the priority list together with the business growth plans, receive input of additional conditions or constraint conditions from an operator, reflect the additional conditions or constraint conditions in the prompt sentence, re-execute the analysis regarding the synergistic effects, the generation of the business growth plans, and the self-evaluation process, and generate an updated priority list.

### Supplementary 3

The system according to supplementary 1,
wherein the processor is configured to
store the prompt sentence, the analysis result regarding the synergistic effects output from the generative artificial intelligence model, the business growth plans, and results of the self-evaluation process on a recording medium, and change a configuration of the prompt sentence or the evaluation criteria based on stored information.

### Example 2

### Supplementary 1

A system comprising a processor,
wherein the processor is configured to
receive, from a user terminal, a plurality of organization-related data items including table-structured data, and execute preprocessing including missing-value completion, outlier removal, encoding, and numerical conversion on the organization-related data to generate preprocessed data,
generate a prompt sentence for causing a trained information processing model including a generative AI model to analyze relationships and synergies among the organization-related data based on the preprocessed data, and input the prompt sentence and the preprocessed data into the generative AI model to obtain analysis results including the relationships and the synergies,
generate a plurality of growth strategies in natural language by using the generative AI model based on the analysis results and the preprocessed data,
for each of the plurality of growth strategies, generate an evaluation prompt sentence describing an evaluation request for a plurality of evaluation indices including growth potential, risk level, and investment effect, input the evaluation prompt sentence and a corresponding growth strategy into the generative AI model or a separate information processing model to obtain numerical evaluation results, and calculate a comprehensive evaluation value of each growth strategy based on the numerical evaluation results, and
order the plurality of growth strategies based on the comprehensive evaluation values to assign ranking information, and provide the growth strategies together with the ranking information to the user terminal as output data.

### Supplementary 2

The system according to supplementary 1,
wherein the processor is configured to
cause the user terminal to generate a display screen of the ranked growth strategies, and, in response to a selection operation or a modification request from the user terminal, re-present detailed information including contents of a selected growth strategy and the evaluation indices, and further input an additional prompt sentence including an improvement request for the selected growth strategy into the generative AI model to generate a revised growth strategy.

### Supplementary 3

The system according to supplementary 1,
wherein the processor is configured to
acquire the organization-related data from a table-data processing program via an application programming interface or a file transfer function, perform the preprocessing in association with a row and column structure in the table-data processing program, and automatically generate the prompt sentence and the evaluation prompt sentence based on results of the preprocessing.

### Application Example 2

### Supplementary 1

A system comprising a processor,
wherein the processor is configured to
receive a data set including organization information and operation information, store the data set in a storage area of a storage device, and perform normalization processing and feature-value calculation processing on the data set,
generate, based on the data set after the feature-value calculation processing and summary information of the data set, a prompt sentence that instructs a generative AI model to analyze the data set and to generate a growth plan or an operation plan, the prompt sentence being dynamically constructed by combining template information with the summary information,
input the generated prompt sentence to the generative AI model, analyze response information acquired from the generative AI model to extract a plurality of growth plans or operation plans, and store the plurality of plans in a plan storage area,
input, for each of the plans stored in the plan storage area, an evaluation prompt sentence to the generative AI model or to a separate evaluation information-processing model so as to acquire numerical evaluation values and reason information for a plurality of evaluation indices including growth potential, risk level, resource-investment efficiency, and feasibility, and store the numerical evaluation values in association with the corresponding plans,
calculate, based on the numerical evaluation values, a composite evaluation value for each plan, rank the plurality of plans according to the composite evaluation values, and generate a ranking result as output data,
transmit the ranked plans to a terminal device based on user operation information received from the terminal device, and receive and store user evaluation information and selection information transmitted from the terminal device, and
input image information and audio information acquired from the terminal device or from an external device into an emotion-recognition process so as to specify emotion information indicating a user emotion state, and add the emotion information to the prompt sentence to be input to the generative AI model, thereby causing the generative AI model to generate or adjust the growth plan or the operation plan in accordance with the user emotion state.

### Supplementary 2

The system according to supplementary 1,
wherein the processor is configured to
acquire logistics operation information as the operation information, the logistics operation information including transportation information, inventory information, and warehousing information, cause the generative AI model to generate, based on the logistics operation information, a plan relating to at least one of a delivery route, a delivery method, and a logistics operation scheme, and perform evaluation and ranking of the plan based on the evaluation prompt sentence.

### Supplementary 3

The system according to supplementary 1,
wherein the processor is configured to
acquire the data set including the organization information or enterprise information from a file created by an information-processing means having a spreadsheet-processing function, and generate the prompt sentence using the data set as an analysis target so that the generative AI model generates a growth plan that maximizes synergy among a plurality of organizations or a plurality of enterprises.

What is claimed is:

1. A system comprising:
circuitry configured to
receive, via a packet-switched network, a plurality of structured data records from a terminal device, each structured data record comprising a set of attribute fields;
execute a preprocessing pipeline on the plurality of structured data records, the preprocessing pipeline comprising detecting absent values and substituting computed aggregate values, converting categorical attribute fields into numerical vector representations, and applying a normalization transformation to numerical attribute fields to generate a set of normalized feature vectors;
construct, from the set of normalized feature vectors, an input tensor for a generative neural network model, the input tensor having a batch dimension corresponding to the plurality of structured data records and a feature dimension corresponding to concatenated numerical and encoded categorical attributes;
generate a structured input sequence for the generative neural network model by combining token embeddings derived from an input character sequence received via the packet-switched network with the input tensor;
execute the generative neural network model using the structured input sequence to produce output token sequences representing a plurality of candidate output data items; and
transmit, via the packet-switched network, the plurality of candidate output data items to the terminal device for rendering on a display of the terminal device.

2. The system according to claim 1, wherein the circuitry is further configured to:
process the input tensor through an encoder subnetwork of the generative neural network model comprising a plurality of self-attention layers and feed-forward sublayers to compute latent representation vectors for each structured data record.

3. The system according to claim 2, wherein the circuitry is further configured to:
compute pairwise relational indicators between latent representation vectors by applying attention-based pooling operations followed by feed-forward layers, each pairwise relational indicator being a scalar value within a predetermined range.

4. The system according to claim 3, wherein the circuitry is further configured to:
compute the pairwise relational indicators as synergy scores representing cooperative effects between pairs of organizations described by the structured data records.

5. The system according to claim 4, wherein the circuitry is further configured to:
condition a decoder subnetwork of the generative neural network model on both the token embeddings and the latent representation vectors using cross-attention mechanisms; and
generate, via the decoder subnetwork, the output token sequences as text-based growth strategy candidates that incorporate the synergy scores.

6. The system according to claim 1, wherein the circuitry is further configured to:
encode each candidate output data item into a fixed-length evaluation vector using a text encoder network; and
process each evaluation vector through a scoring network to produce a plurality of numerical evaluation indices.

7. The system according to claim 6, wherein the circuitry is further configured to:
compute a composite score for each candidate output data item by applying a weighted aggregation function to the plurality of numerical evaluation indices; and
sort the plurality of candidate output data items according to the composite scores to generate a ranked output list.

8. The system according to claim 7, wherein the plurality of numerical evaluation indices comprise at least a growth potential index, a risk index, an investment effectiveness index, and a feasibility index.

9. The system according to claim 8, wherein the circuitry is further configured to:
transmit the ranked output list to the terminal device; and
receive, via the packet-switched network, selection data from the terminal device indicating at least one selected candidate output data item.

10. The system according to claim 1, wherein the preprocessing pipeline further comprises:
parsing a tabular data file received from the terminal device into an in-memory data structure preserving row and column relationships; and
mapping each column to a feature encoding rule stored in a schema definition.

11. The system according to claim 10, wherein converting categorical attribute fields into numerical vector representations comprises:
assigning integer indices to categorical labels; and
generating one-hot encoded vectors or embedding indices for each categorical value.

12. The system according to claim 11, wherein the normalization transformation comprises at least one of:
a standardization transformation that subtracts a column-wise mean and divides by a column-wise standard deviation; or
a min-max scaling transformation that maps values into a fixed numerical range.

13. The system according to claim 1, wherein the circuitry is further configured to:
store the set of normalized feature vectors and the latent representation vectors in a storage device with associated metadata comprising preprocessing parameters and model version identifiers; and
upon receiving a subsequent input character sequence referencing the same structured data records, reuse the stored normalized feature vectors and latent representation vectors without re-executing the preprocessing pipeline.

14. The system according to claim 13, wherein reusing the stored normalized feature vectors reduces processor cycles and memory bandwidth consumption by avoiding redundant tensor construction and encoder inference operations.

15. The system according to claim 1, wherein the generative neural network model comprises a transformer-based architecture including:
a multi-head self-attention mechanism that computes context-dependent representations;
position-wise feed-forward networks with non-linear activation functions; and
layer normalization applied after each sublayer.

16. The system according to claim 15, wherein the circuitry is further configured to:
generate the output token sequences using a decoding procedure selected from beam search, top-k sampling, or nucleus sampling; and
control diversity of the output token sequences by adjusting at least one of a temperature parameter, a top-k value, or a top-p value.

17. The system according to claim 1, wherein the circuitry is further configured to:
perform emotion-recognition processing on image data and audio data received from the terminal device to produce an affective state indicator; and
incorporate the affective state indicator into the structured input sequence for the generative neural network model.

18. A system comprising:
circuitry configured to
receive, via a packet-switched network, a plurality of structured data records each comprising categorical and numerical attribute fields from a terminal device;
execute a preprocessing pipeline comprising absent-value substitution, categorical-to-numerical encoding, and normalization to generate normalized feature vectors;
construct an input tensor from the normalized feature vectors;
process the input tensor through an encoder subnetwork comprising multi-head self-attention layers to compute latent representation vectors;
compute pairwise relational indicators between latent representation vectors;
generate a structured input sequence combining token embeddings from an input character sequence with the latent representation vectors and the pairwise relational indicators;
execute a decoder subnetwork of a generative neural network model conditioned on the structured input sequence to produce a plurality of candidate output data items;
encode each candidate output data item into an evaluation vector and process the evaluation vector through a scoring network to produce numerical evaluation indices;
compute a composite score for each candidate output data item and rank the candidate output data items; and
transmit, via the packet-switched network, a ranked list of candidate output data items to the terminal device for rendering on a display of the terminal device.

19. The system according to claim 18, wherein the circuitry is further configured to:
receive, from the terminal device, constraint parameters; and
regenerate the structured input sequence incorporating the constraint parameters and re-execute the decoder subnetwork to produce updated candidate output data items.

20. A method performed by a system comprising circuitry, the method comprising:
receiving, via a packet-switched network, a plurality of structured data records from a terminal device, each structured data record comprising a set of attribute fields;
executing a preprocessing pipeline on the plurality of structured data records, the preprocessing pipeline comprising detecting absent values and substituting computed aggregate values, converting categorical attribute fields into numerical vector representations, and applying a normalization transformation to numerical attribute fields to generate a set of normalized feature vectors;
constructing, from the set of normalized feature vectors, an input tensor for a generative neural network model, the input tensor having a batch dimension corresponding to the plurality of structured data records and a feature dimension corresponding to concatenated numerical and encoded categorical attributes;
generating a structured input sequence for the generative neural network model by combining token embeddings derived from an input character sequence received via the packet-switched network with the input tensor;
executing the generative neural network model using the structured input sequence to produce output token sequences representing a plurality of candidate output data items; and
transmitting, via the packet-switched network, the plurality of candidate output data items to the terminal device for rendering on a display of the terminal device.
